(19) United States
(12) Patent Application Publication
(10) Pub. No.: US 2010/0007992 A1
(43) Pub. Date: Jan. 14, 2010

(54) Magnetic head assembly and magnetic recording apparatus

(75) Inventors: Kenichiro Yamada, Tokyo (JP); Hitoshi Iwasaki, Kanagawa-ken (JP); Masayuki Takagishi, Tokyo (JP); Tomomi Funayama, Tokyo (JP); Masahiro Takashita, Kanagawa-ken (JP); Mariko Shimizu, Kanagawa-ken (JP); Soichi Oikawa, Tokyo (JP); Katsuhiko Koui, Kanagawa-ken (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/453,855

(22) Filed: May 26, 2009

(30) Foreign Application Priority Data
Jul. 11, 2008 (JP) 2008-181911

(51) Int. Cl. G11B 5/48

(52) U.S. Cl. 360/244; G9B/5.147

(57) ABSTRACT

A magnetic head assembly includes a magnetic recording head, a head slider, a suspension and an actuator arm. The magnetic recording head includes: a main magnetic pole; an adjustment magnetic pole provided together with the main magnetic pole; a spin torque oscillator; a main magnetic pole coil being wound around the main magnetic pole; and an adjustment magnetic pole coil being wound around the adjustment magnetic pole. At least part of the spin torque oscillator is provided between the main magnetic pole and the adjustment magnetic pole. A way of winding of the adjustment magnetic pole coil is different from a way of winding of the main magnetic pole coil. The magnetic recording head is mounted on the head slider. The head slider is mounted on one end of the suspension. The actuator arm is connected to the other end of the suspension.

### CROSS-REFERENCE TO RELATED APPLICATIONS

This application is based upon and claims the benefit of priority from the prior Japanese Patent Application No.2008-181911, filed on Jul. 11, 2008; the entire contents of which are incorporated herein by reference.

### BACKGROUND OF THE INVENTION

This invention relates to a magnetic head assembly and a magnetic recording apparatus.

### BACKGROUND ART

In the 1990s, practical application of MR (Magneto-Resistive effect) head and GMR (Giant Magneto-Resistive effect) head has acted as a trigger and recording density and recording capacity of HDD (Hard Disk Drive) have drastically increased. However, in the 2000s, the problem of thermal fluctuation of the magnetic recording media has been actualized and therefore the speed of the increase of the recording density has temporarily slowed down. Even so, it has played a leading role that perpendicular magnetic recording, which is fundamentally more advantageous than the longitudinal magnetic recording in high-density recording, has been put into practical use in 2005, and nowadays, the recording density of HDD has been grown by about 40% per year.

In the latest recording density verification test, the level of more than 400 Gbits/inch² has been achieved, and if the recording density steadily develops continuously, it has been anticipated that the recording density of 1 Tbits/inch² will be realized in about 2012. However, it is thought that realization of such high recording density is not easy even by using the perpendicular magnetic recording scheme because the problem of thermal fluctuation is actualized again.

As a recording scheme that can solve such a problem, “high-frequency magnetic-field assist recording scheme” has been proposed (for example, U.S. Pat. No. 6,011,664, hereinafter referred to as Patent document 1). In the high-frequency magnetic-field assist recording scheme, a high-frequency magnetic field in the vicinity of resonant frequency of the magnetic recording medium which is sufficiently higher than recording signal frequency is applied locally to the medium. As a result, the medium resonates and the coercivity (Hc) of the medium of a portion to which the high-frequency magnetic field is applied decreases to half or less of its original coercivity. By utilizing this effect to superpose the recording magnetic field on high-frequency magnetic field, magnetic recording on the medium of higher coercivity (Hc) and higher magnetic anisotropic energy (Ku) becomes possible. However, in the technique disclosed in the Patent document 1, the high-frequency magnetic field is generated by a coil and therefore it has been difficult to efficiently apply the high-frequency magnetic field to the medium.

Accordingly, as a means for generating the high-frequency magnetic field, techniques for utilizing a spin torque oscillator have been proposed (for example, US Patent Application Publications No. 2005/0023938A1, No. 2005/0219771A1, and No. 2008/0019040A1, hereinafter referred to as Patent documents 2 to 4, respectively and IEEE TRANSACTION ON MAGNETICS, VOL. 42, NO. 10, PP. 2670 “Bias-Field-Free Microwave Oscillator Driven by Perpendicularly Polarized Spin Current” by Xiaochun Zhu and Jian-Gang Zhu, hereinafter referred to as Non-patent document 1). In the techniques disclosed therein, the spin torque oscillator is composed of a spin injection layer, an intermediate layer, a magnetic body layer, and an electrode. When a direct current is passed through the spin torque oscillator via the electrode, magnetization of the magnetic layer generates ferromagnetic resonance by spin torque generated by the spin injection layer. As a result, the high-frequency magnetic field is generated from the spin torque oscillator.

The size of the spin torque oscillator is about several tens of nanometers and therefore the generated high-frequency magnetic field is localized in the region of about several tens of nanometers in the vicinity of the spin torque oscillator. Furthermore, by the longitudinal component of the high-frequency magnetic field, the perpendicularly magnetized medium can be efficiently resonated and the coercivity of the medium can be drastically lowered. As a result, only in a portion where the recording magnetic field by the main magnetic pole and the high-frequency magnetic field by the spin torque oscillator are superposed, the high-density magnetic recording is performed, and the medium of high coercivity (Hc) and high magnetic anisotropic energy (Ku) can be utilized. Therefore, the problem of thermal fluctuation in the high-density recording can be avoided.

In the magnetic recording head having the spin torque oscillator, it becomes important that the spin torque oscillator and the main magnetic pole are approximated and that longitudinal high-frequency magnetic field and oblique recording magnetic field are efficiently superposed in the magnetic recording medium and that the oscillation frequency of the spin torque oscillator is set to be almost equal to the resonant frequency of the magnetic recording medium. However, when the spin torque oscillator and the main magnetic pole are approximated, a large magnetic field of 5 kOe to 20 kOe is applied to the spin torque oscillator from the main magnetic pole in writing. As a result, the oscillation frequency of the spin torque oscillator shifts, and lowering of coercivity of the magnetic recording medium by the high-frequency magnetic field from the spin torque oscillator becomes unstable, and this becomes a factor of preventing the stable and high-quality high-frequency magnetic field assist recording.

Therefore, in the high-frequency magnetic field assist recording scheme, for realizing uniform and stable recording, it is required to realize stabilization of the oscillation frequency of the spin torque oscillator.

Furthermore, also in the case of setting the oscillation frequency of the spin torque oscillator and the medium resonant frequency to be almost equal in designing, in the magnetic recording head completed through various production processes, the oscillation frequency varies for each of the magnetic recording heads due to, for example, variation of production conditions. As a result, the oscillation frequency of the spin torque oscillator shifts from the medium resonant frequency, and the yield of the magnetic recording head lowers, and this becomes a factor of preventing the high-quality high-frequency magnetic field assist recording.

Therefore, in the high-frequency assist recording scheme, for realizing uniform and stable recording, it is required to realize uniformization of the oscillation frequency of the spin torque oscillator even if the production condition varies,

### SUMMARY OF THE INVENTION

According to an aspect of the invention, there is provided a magnetic head assembly including: a magnetic recording head including: a main magnetic pole; an adjustment magnetic pole provided together with the main magnetic pole; a spin torque oscillator, at least part of the spin torque oscillator being provided between the main magnetic pole and the adjustment magnetic pole; a main magnetic pole coil configured to be wound around the main magnetic pole; and an adjustment magnetic pole coil configured to be wound around the adjustment magnetic pole, a way of winding of the adjustment magnetic pole coil being different from a way of winding of the main magnetic pole coil; a head slider, the magnetic recording head being mounted on the head slider; a suspension, the head slider being mounted on one end of the suspension; and an actuator arm connected to other end of the suspension.

According to another aspect of the invention, there is provided a magnetic head assembly including: a magnetic recording head including: a main magnetic pole; an adjustment magnetic pole provided together with the main magnetic pole; a spin torque oscillator, at least part of the spin torque oscillator being provided between the main magnetic pole and the adjustment magnetic pole; a main magnetic pole coil configured to be wound around the main magnetic pole; and an adjustment magnetic pole coil configured to be wound around the adjustment magnetic pole, a current being supplied to the adjustment magnetic coil independently of the main magnetic pole coil; a head slider, the magnetic recording head being mounted on the head slider; a suspension, the head slider being mounted on one end of the suspension; and an actuator arm connected to other end of the suspension.

According to another aspect of the invention, there is provided a magnetic recording apparatus including: a magnetic recording medium; a magnetic head assembly including: a magnetic recording head including; a main magnetic pole, an adjustment magnetic pole provided together with the main magnetic pole; a spin torque oscillator, at least part of the spin torque oscillator being provided between the main magnetic pole and the adjustment magnetic pole; a main magnetic pole coil configured to be wound around the main magnetic pole; and an adjustment magnetic pole coil configured to be wound around the adjustment magnetic pole, a way of winding of the adjustment magnetic pole coil being different from a way of winding of the main magnetic pole coil; a head slider, the magnetic recording head being mounted on the head slider; a suspension, the head slider being mounted on one end the suspension; and an actuator arm connected to the other end of the suspension; and a signal processor configured to write and read a signal on the magnetic recording medium by using the magnetic recording head mounted on the magnetic head assembly.

### BRIEF DESCRIPTION OF THE DRAWINGS

FIG. 1 is a schematic perspective view illustrating the configuration of a magnetic recording head according to a first embodiment of the invention;

FIG. 2 is a schematic perspective view illustrating the structure of a head slider on which the magnetic recording head according to the first embodiment of the invention is mounted;

FIG. 3 is a schematic perspective view illustrating the structure of a spin torque oscillator used in the magnetic recording head according to the first embodiment of the invention;

FIG. 4 is a schematic perspective view illustrating the structure of a relevant part of the magnetic recording head according to the first embodiment of the invention;

FIGS. 5A and 5B show graphs illustrating characteristics of the magnetic recording head according to the first embodiment of the invention;

FIG. 6 is a schematic perspective view illustrating the structure of a relevant part of another magnetic recording head according to the first embodiment of the invention;

FIG. 7 is a schematic perspective view illustrating the structure of a substantial part of a magnetic head according to a second embodiment of the invention;

FIGS. 8A and 8B are schematic magnetic views illustrating characteristics of currents that can be used in the magnetic recording head according to the second embodiment of the invention;

FIG. 9 is a schematic perspective view illustrating the structure of a relevant part of another magnetic recording head according to the second embodiment of the invention;

FIGS. 10A and 10B are schematic views illustrating characteristics of currents that can be used in another magnetic recording head according to the second embodiment of the invention;

FIGS. 11A and 11B are schematic views illustrating characteristics of other currents that can be used in the magnetic recording head according to the second embodiment of the invention;

FIG. 12 is a schematic perspective view illustrating the structure of a relevant part of another magnetic recording head according to the second embodiment of the invention;

FIG. 13 is a schematic perspective view illustrating the structure of a relevant part of a magnetic recording head according to a third embodiment of the invention;

FIG. 14 is a schematic perspective view illustrating the structure of a relevant part of another magnetic recording head according to the third embodiment of the invention;

FIG. 15 is a schematic perspective view illustrating the structure of a relevant part of another magnetic recording head according to the third embodiment of the invention;

FIG. 16 is a schematic perspective view illustrating the structure of a relevant part of another magnetic recording head according to the third embodiment of the invention;

FIG. 17 is a schematic perspective view illustrating the structure of a relevant part of another magnetic recording head according to the third embodiment of the invention;

FIG. 18 is a schematic perspective view illustrating the structure of a spin torque oscillator used in a magnetic recording head according to a fourth embodiment of the invention;

FIG. 19 is a schematic perspective view illustrating the structure of a relevant part of a magnetic recording head according to a fifth embodiment of the invention;

FIGS. 20A and 20B are schematic views illustrating the structure of a relevant part of a magnetic recording head according to a sixth embodiment of the invention;

FIG. 21 is a schematic perspective view illustrating the configuration of a magnetic recording apparatus according to a seventh embodiment of the invention;

FIGS. 22A and 22B are schematic perspective views illustrating the configuration of one part of the magnetic recording apparatus according to the seventh embodiment of the invention;

FIG. 23 is a schematic view illustrating the configuration of a relevant part of a magnetic recording apparatus according to an eighth embodiment of the invention;

FIG. 24 is a schematic view illustrating the configuration of a relevant part of a magnetic recording apparatus according to a ninth embodiment of the invention;

FIGS. 25A to 25C are schematic views illustrating the operation of the magnetic recording apparatus according to the ninth embodiment of the invention;

FIG. 26 is a schematic view illustrating the configuration of a magnetic recording apparatus according to a tenth embodiment of the invention;

FIGS. 27A to 27C are schematic views illustrating the operation in the magnetic recording apparatus according to the tenth embodiment of the invention;

FIG. 28 is a schematic view illustrating the configuration of another magnetic recording apparatus according to the tenth embodiment of the invention;

FIGS. 29A and 29B are schematic perspective views illustrating the configuration of the magnetic recording medium of the magnetic recording apparatus according to the embodiment of the invention; and

FIGS. 30A and 30B are schematic perspective views illustrating configuration of another magnetic recording medium of the magnetic recording apparatus according to the embodiment of the invention.

### DETAILED DESCRIPTION OF THE INVENTION

Hereinafter, embodiments of the invention will now be described with reference to drawings.

The drawings are schematic or conceptual. And, relation of thickness to width of each of components, specific coefficient of scales of members, and so forth are not necessarily the same as the actual ones. Moreover, even when the same portions are shown, the scales or specific coefficients are occasionally shown to be different from each other by the drawings.

Moreover, in the specification and each of the drawings, the same signs will be appended to the same components as described with respect to a previously presented figure, and the detailed description thereof will be appropriately omitted.

### First Embodiment

A magnetic recording head according to a first embodiment of the invention will be described with assuming the case of recording on a multiparticle medium for perpendicular magnetic recording.

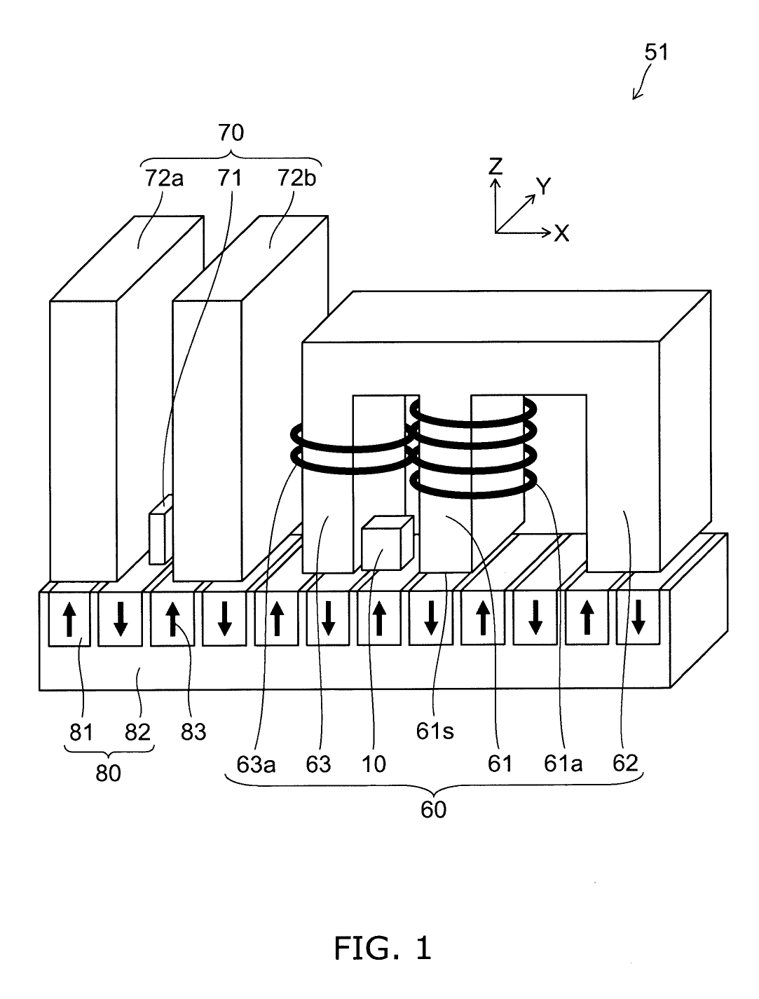

FIG. 1 is a schematic perspective view illustrating the configuration of the magnetic recording head according to the first embodiment of the invention.

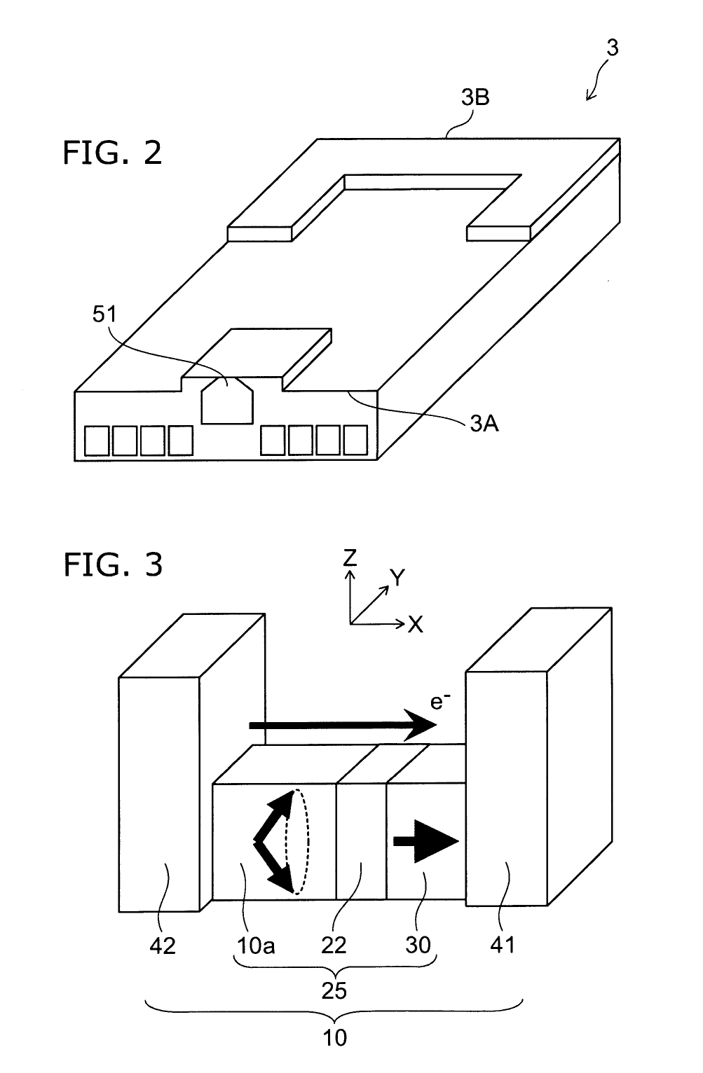

FIG. 2 is a schematic perspective view illustrating the structure of a head slider on which the magnetic recording head according to the first embodiment of the invention is mounted.

FIG. 3 is a schematic perspective view illustrating the structure of a spin torque oscillator used in the magnetic recording head according to the first embodiment of the invention.

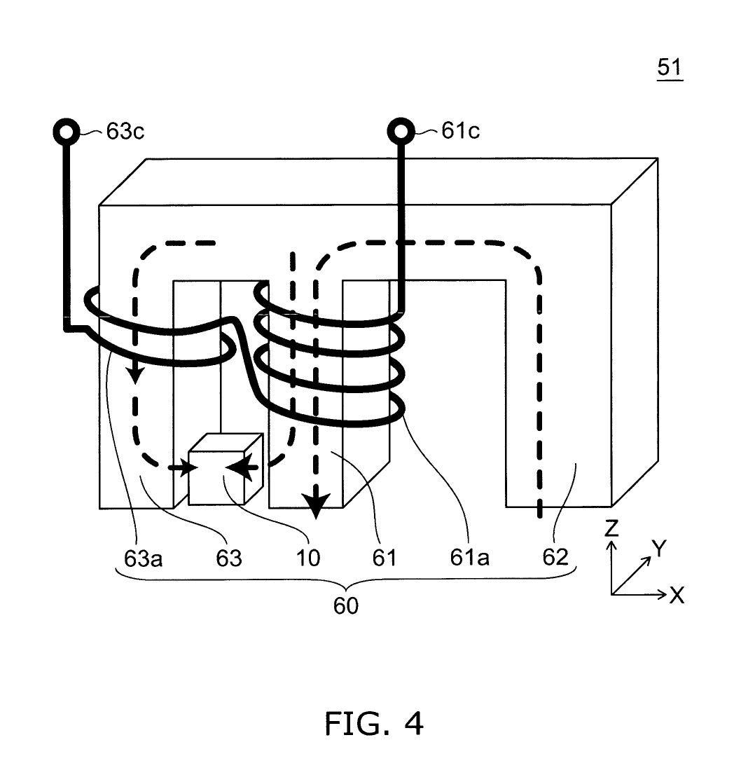

FIG. 4 is a schematic perspective view illustrating the structure of a relevant part of the magnetic recording head according to the first embodiment of the invention.

As shown in FIG. 1, the magnetic recording head 51 according to the first embodiment of the invention includes a main magnetic pole 61 for applying a recording magnetic field to a magnetic recording medium 80, an adjustment magnetic pole 63 provided in parallel in the vicinity of the main magnetic pole 61, a spin torque oscillator 10 provided between the main magnetic pole 61 and the adjustment magnetic pole 63, a main magnetic pole coil 61a for magnetizing the main magnetic pole 61, and an adjustment magnetic pole coil 63a for magnetizing the adjustment magnetic pole 63 in which a way of winding the coil is different from the main magnetic pole coil 61a. The way of winding the coil includes the number of winding times of the coil and the winding direction of the coil. The main magnetic pole coil 61a is wound around the main magnetic pole 61. The adjustment magnetic pole coil 63a is wound around the adjustment magnetic pole 63.

In a specific example illustrated in FIG. 1, the spin torque oscillator 10 is provided between the main magnetic pole 61 and the adjustment magnetic pole 63, and as described later, the adjustment magnetic pole 63 may be provided so as to be recessed from the air bearing surface 61s of the main magnetic pole 61, in this case, part of the spin torque oscillator 10 is provided between the main magnetic pole 61 and the adjustment magnetic pole 63. As described above, it is sufficient that at least part of the spin torque oscillator 10 is provided between the main magnetic pole 61 and the adjustment magnetic pole 63.

The above main magnetic pole 61, the spin torque oscillator 10, the adjustment magnetic pole 63, the main magnetic pole coil 61a, and the adjustment magnetic pole coil 63a are included in a writing head section 60.

The writing head section 60 can further include a return path (shield) 62.

As shown in FIG. 1, in the magnetic recording head 51 according to this embodiment, a reproducing head section (reading head section) 70 can be further provided.

The reproducing head section 70 includes a first magnetic shield layer 72a, a second magnetic shield layer 72b, a magnetic reproducing element 71 provided between the first magnetic shield layer 72a and the second magnetic shield layer 72b.

Components of the above reproducing head section 70 and components of the above writing head section 60 are separated by insulator such as alumina, which is not shown.

As the magnetic reproducing element 71, GMR element or TMR (Tunnel Magneto-Resistive effect) element or the like can be utilized. For enhancing the reproducing resolution, the magnetic reproducing element 71 is disposed between the two magnetic shield layers, namely, the first and second magnetic shield layers 72a, 72b.

As shown in FIG. 1, a magnetic recording medium 80 is disposed to be opposed to the air bearing surface 61s of the magnetic recording head 51. And, the main magnetic pole 61 applies recording magnetic field to the magnetic recording medium 80. The air bearing surface 61s of the magnetic recording head 51 can be the main surface of the main magnetic pole 61s opposed to the magnetic recording medium 80 disposed to the magnetic recording head 51.

For example, as shown in FIG. 2, the magnetic recording head 51 is mounted on the head slider 3. The head slider 3 is made of Al₂O₃/TiC or the like, and designed and fabricated so as to be capable of relatively moving to the magnetic recording medium 80 such as a magnetic disk while floating thereabove or being in contact with therewith.

The head slider 3 has an air inflow side 3A and an air outflow side 3B, and the magnetic recording head 51 is disposed on a side surface or the like of the air outflow side 3B. Thereby, the magnetic recording head 51 mounted on the head slider 3 relatively moves to the magnetic recording medium 80 while floating thereabove or being in contact therewith.

As shown in FIG. 1, the magnetic recording medium 80 has a medium substrate 82 and magnetic recording layers 81 provided thereon. The magnetization 83 of the magnetic recording layer 81 is controlled to a predetermined direction by the magnetic field applied by the writing head section 60, and thereby writing is performed.

On the other hand, the reproducing head section 70 reads the direction of the magnetization of the magnetic recording layer 81.

Here, as shown in FIG. 1, the direction perpendicular to the surface opposed to the adjustment magnetic pole 63 and directing from the adjustment magnetic pole 63 toward the main magnetic pole 61 is set to be X axis, and the axis perpendicular to the X axis and parallel to the air bearing surface 61s of the main magnetic pole 61 is set to be Y axis. The direction perpendicular to the X axis and the Y axis is set to be Z axis. Therefore, the Z axis is perpendicular to the air bearing surface 61s.

As shown in FIG. 3, the spin torque oscillator 10 provided in the magnetic recording head 51 has the structure in which a first electrode 41, a spin injection layer 30, an intermediate layer 22 having high spin transmittance, an oscillation layer 10a, and a second electrode 42 are stacked in this order.

That is, the spin torque oscillator 10 has a stacked body 25 having, a first magnetic layer (oscillation layer 10a) having a smaller coercivity than the magnetic field applied by the main magnetic pole 61, a second magnetic layer (spin injection layer 30) having a smaller coercivity than the magnetic field applied by the main magnetic pole 61, and an intermediate layer 22 provided between the first magnetic layer and the second magnetic layer.

Furthermore, the spin torque oscillator 10 further has a pair of electrodes (first electrode 41 and second electrode 42) that can supply a current to the stacked body 25.

The main surfaces of these layers are perpendicular to the X axis, namely, the stacking direction is parallel to the X axis. However, the invention is not limited thereto, and the stacking direction of the stacked body 25 may be parallel to the Y axis.

In the specific example illustrated in FIG. 3, the side of the first electrode 41 (namely, the side of the spin injection layer 30) is disposed on the side of the main magnetic pole 61, and the side of the second electrode 42 (namely, the side of the oscillation layer 10a) is disposed on the side of the adjustment magnetic pole 63. However, the invention is not limited thereto, and the side of the second electrode 42 (namely, the side of the oscillation layer 10a) may be disposed on the side of the main magnetic pole 61, and the side of the first electrode 41 (namely, the side of the spin injection layer 30) may be disposed on the side of the adjustment magnetic pole 63.

In the spin torque oscillator 10, by passing a driving current through the second electrode 42 and the first electrode 41, a high-frequency magnetic field can be generated by the oscillation layer 10a. It is desirable that a driving current density is set to be 5×10⁷ A/cm² to 1×10⁹ A/cm², and the driving current density is appropriately adjusted to be in a desired oscillation state.

The first electrode 41 and the second electrode 42 can be made of a material such as Ti or Cu having low electric resistance and being difficult to be oxidized.

At least any one of the first electrode 41 and the second electrode 42 may double as, for example, at least any one of the main magnetic pole 61 and the adjustment magnetic pole 63.

The intermediate layer 22 can be made of a material having high spin transmittance such as Cu, Au, and Ag. It is preferable that the film thickness of the intermediate layer 22 is one atom layer to 5 nm. Thereby, the exchange coupling between the oscillation layer 10a and the spin injection layer 30 can be adjusted to be the most appropriate value.

The oscillation layer 10a can be made of a high-BS soft magnetic material (FeCo/NiFe stacked film) generating a magnetic field during oscillation and it is preferable that the film thickness of the oscillation layer 10a is from 5 nm to 40 nm.

The spin injection layer 30 can be made of a CoPt alloy with the magnetization oriented in a perpendicular direction (X axis direction) to the film surface, and it is preferable that the film thickness of the spin injection layer 30 is from 2 nm to 60 nm.

Each of the spin injection layer 30 and the oscillation layer 10a can be made of a soft magnetic layer that has a relatively large saturation magnetic flux density and has magnetic anisotropy in a direction longitudinal to the film surface such as CoFe or CoNiFe or NiFe or CoZrNb or FeN or FeSi or FeAlSi, or a CoCr-based magnetic alloy film in which the magnetization is oriented in a direction longitudinal to the film surface.

Furthermore, each of the spin injection layer 30 and the oscillation layer 10a can be appropriately made of a material having excellent perpendicular orientation such as, a CoCr-based magnetic layer such as CoCrPt or CoCrTa or CoCrTaPt or CoCrTaNb, a RE-TM-based amorphous alloy magnetic layer such as TbFeCo, a Co artificial lattice magnetic layer such as Co/Pd or Co/Pt or CoCrTa/Pd, a CoPt-based or FePt-based alloy magnetic layer, or a SmCo-based alloy magnetic layer, with the magnetization oriented in a perpendicular direction (X axis direction) to the film surface.

Each of the spin injection layer 30 and the oscillation layer 10a may be a layer in which a plurality of the above materials are stacked. Thereby, saturation magnetic flux density (Bs) and anisotropic magnetic field (Hk) of each of the spin injection layer 30 and the oscillation layer 10a can be easily adjusted.

On the other hand, each of the main magnetic pole 61 and the adjustment magnetic pole 63 and the return path 62 can be made of a soft magnetic layer having a comparatively large saturation magnetic flux density such as FeCo, CoFe, CoNiFe, NiFe, CoZrNb, FeN, FeSi, or FeAlSi.

In each of the main magnetic pole 61 and the adjustment magnetic pole 63, a materials of a portion of the side of the air bearing surface 61s and a portion except therefor may be different. For example, for enhancing the magnetic field generated in the magnetic recording medium 80 or the spin torque oscillator 10, the material of the portion of the side of the air bearing surface 61s may be FeCo, CoNiFe, FeN or the like having particularly large saturation magnetic flux density, and the material of the portion except therefor may be NiFe or the like having particularly high magnetic permeability. For enhancing the magnetic field generated in the magnetic recording medium 80 or the spin torque oscillator 10, the shape of at least any one of the main magnetic pole 61 and the adjustment magnetic pole 63 on the side of the air bearing surface 61s may be smaller than the back gap portion. Thereby, the magnetic flux concentrates on the portion of the side of the air bearing surface 61s, and the magnetic field of high intensity can be generated.

Each of the main magnetic pole coil 61a and the adjustment magnetic pole coil 63a can be made of a material such as Ti or Cu having low electric resistance and being difficult to be oxidized.

As shown in FIG. 4, in the magnetic recording head 51 according to this embodiment, the main magnetic pole coil 61a and the adjustment magnetic pole coil 63a are electrically connected inside. That is, the main magnetic pole coil 61a and the adjustment magnetic pole coil 63a are serially connected. Thereby, a recording current is passed between the terminal 61c of the main magnetic pole coil 61a and the terminal 63c of the adjustment magnetic pole coil 63a, and thus, the current can be passed through both the main magnetic pole coil 61a and the adjustment magnetic pole coil 63a.

As shown in FIG. 4, the terminals for supplying the current to the main magnetic pole coil 61a and the adjustment magnetic pole coil 63a are the two of the terminal 61c and the terminal 63c. In the case of not providing the adjustment magnetic pole 63 and the adjustment magnetic pole coil 63a in a conventional technique, the main magnetic pole 61 is provided with two terminals of the main magnetic pole coil 61a, and in the recording head 51 according to this embodiment, even when the adjustment magnetic pole 63 and the adjustment magnetic pole coil 63a are provided, two terminals are also provided, and the same number of the terminals as the case of the conventional technique is held, and the structure thereof is simple and the production thereof is easily done, and there is an advantage in cost.

In the magnetic recording head 51, writing on the magnetic recording medium 80 disposed to be opposed to the air bearing surface 61s is performed in the superposed region of the recording magnetic field by the main magnetic pole 61 and the high-frequency magnetic field by the spin torque oscillator 10.

In the magnetic recording head 51 according to this embodiment, the ways of winding the coils are set to be different between the main magnetic pole coil 61a and the adjustment magnetic pole coil 63a. In this specific example, the number of winding (number of winding times) is set to be different. And, between the main magnetic pole coil 61a and the adjustment magnetic pole coil 63a, the winding directions of the coils (winding directions) are set to be the same, and thereby, intensity of the magnetic field generated in the main magnetic pole 61 and intensity of the magnetic field generated in the adjustment magnetic pole 63 are set to be different, and at the same time, the magnetic fields have reversed phases.

The winding direction of the coil (winding direction) can be a clockwise direction or an anticlockwise direction when the main magnetic pole coil 61a and the adjustment magnetic pole coil 63a are viewed from, for example, the air bearing surface 61s.

Thereby, the intensity of the magnetic field applied from the main magnetic pole 61 to the spin torque oscillator 10 and the intensity of the magnetic field applied from the adjustment magnetic pole 63 to the spin torque oscillator 10 can be different, and at the same time, the direction of the magnetic field from the main magnetic pole 61 to the spin torque oscillator 10 and the direction of the magnetic field from the adjustment magnetic pole 63 to the spin torque oscillator 10 can be substantially anti-parallel.

As a result, even if the recording current in the main magnetic pole 61 is changed, the change of the intensity of the magnetic field applied to the spin torque oscillator 10 can be small.

For example, in the hard disk apparatus, the recording currents are changed among an inner circumference, an intermediate circumference and an outer circumference, and thereby, the writing magnetic field on the magnetic recording medium 80 is optimized. In a conventional magnetic recording head having a spin torque oscillator, during adjusting the recording current, the intensity of the magnetic field applied to the spin torque oscillator varies largely. Because the oscillation frequency of the spin torque oscillator is almost proportional to the intensity of the applied magnetic field, if the intensity of the magnetic field varies largely, the oscillation frequency of the spin torque oscillator varies also largely. As a result, the oscillation of frequency of the spin torque oscillator shifts from the resonant frequency of the magnetic recording medium 80, and the uniform high-frequency magnetic-field assist recording cannot be realized.

By contrast, in the magnetic field head 51 according to this embodiment, the adjustment magnetic pole 63 is provided and the magnetic field generated in the adjustment magnetic pole 63 is applied to the spin torque oscillator 10. Even when the recording current of the main magnetic pole 61 is adjusted to change by adjusting this magnetic field, the intensity of the magnetic field received by the spin torque oscillator 10 can be constant, and the oscillation frequency of the spin torque oscillator 10 can be substantially constant. Thereby, even if the recording current is changed, the spin torque oscillator 10 can maintain the high-frequency magnetic field adapted to the resonant frequency of the magnetic recording medium 80.

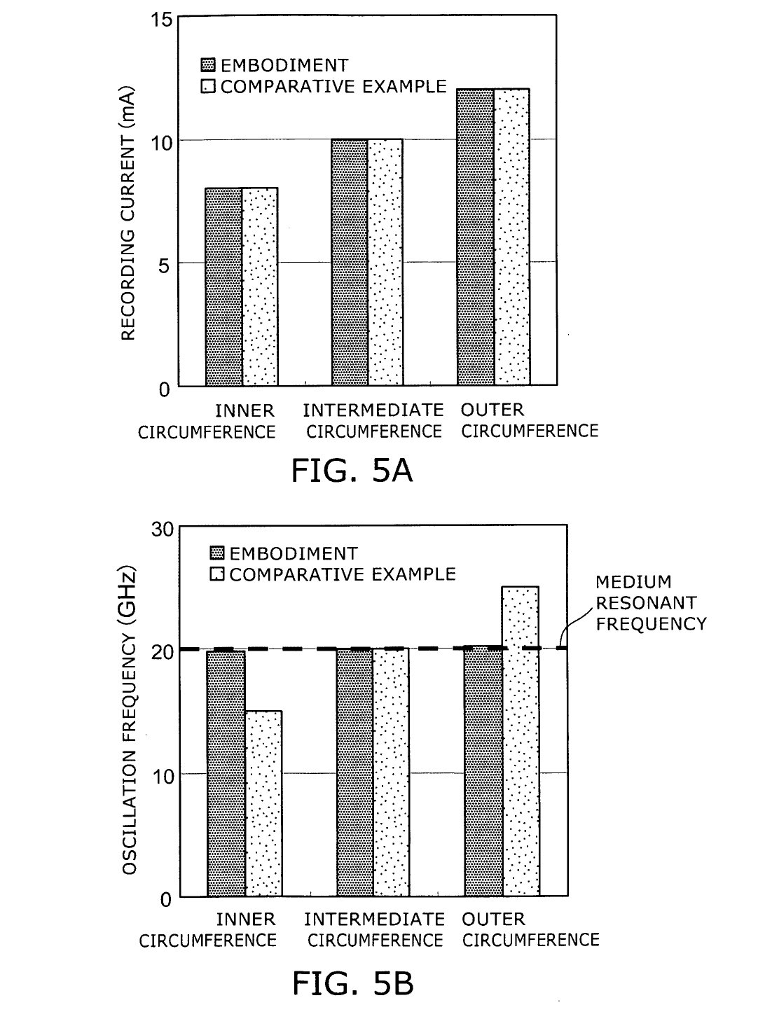

FIGS. 5A and 5B show graphs illustrating characteristics of the magnetic recording head according to the first embodiment of the invention.

In the FIGS. 5A and 5B, the horizontal axis represents the place (inner circumference, intermediate circumference, or outer circumference) of the magnetic recording medium 80 to which the magnetic recording head 51 is opposed, and the vertical axis of FIG. 5A represents the recording current, and the vertical axis of FIG. 5B represents the oscillation frequency of the spin torque oscillator 10. And, in FIGS. 5A and 5B, characteristics of the magnetic recording head 51 according to this embodiment and characteristics of the magnetic recording head 51x of the comparative example are illustrated. The magnetic recording head 51x of the comparative example is not provided with the adjustment magnetic pole 63 and the adjustment magnetic pole coil 63a in the magnetic recording head 51 according to this embodiment. The structures other than this are the same as the magnetic recording head 51 according to this embodiment, and therefore, the structures are not particularly shown.

As shown in FIG. 5A, in the cases of both of the magnetic recording heads 51, 51x of this embodiment and the comparative example, the recording current is changed corresponding to the inner circumference, the intermediate circumference and the outer circumference of the magnetic recording medium 80. That is, for example, the recording current of the intermediate circumference is set to be larger than that of the inner circumference, and the recording current of the outer circumference is set to be larger than that of the intermediate circumference. And, the recording currents are the same in both of the magnetic recording heads 51, 51x of this embodiment and the comparative example.

On the other hand, as shown in FIG. 5B, in the case of the magnetic recording head 51x of the comparative example, the oscillation frequency of the spin torque oscillator 10 increases from the inner circumference to the outer circumference. A shift is caused with respect to the resonant frequency of the magnetic recording medium 80. That is, in the intermediate circumference, the oscillation frequency of the spin torque oscillator 10 is approximately to the same as the resonant frequency of the magnetic recording medium 80. However, in the inner circumference, the oscillation frequency of the spin torque oscillator 10 is lower than the oscillation frequency of the magnetic recording medium 80, and in the outer circumference, the oscillation frequency of the spin torque oscillator 10 is higher than the resonant frequency of the magnetic recording medium. As described above, in the magnetic recording head 51x of the comparative example, the oscillation frequency of the spin torque oscillator 10 shifts from the resonant frequency of the magnetic recording medium 80, and lowering of the coercivity of the magnetic recording layer 81 of the magnetic recording medium 80 becomes unstable, and the suitable high-frequency magnetic-field assist recording cannot be realized.

By contrast, as shown in FIG. 5B, in the magnetic recording head 51 according to this embodiment, the magnetic field adjusted by the adjustment magnetic pole 63 is applied to the spin torque oscillator 10, and thereby, in every case of the inner circumference, the intermediate circumference and the outer circumference, the oscillation frequency of the spin torque oscillator 10 can be set to be substantially the same as the resonant frequency of the magnetic recording medium 80. Thereby, the coercivity of the magnetic recording layer 81 of the magnetic recording medium 80 can be stably lowered, and the suitable high-frequency magnetic-field assist recording can be realized.

As described above, according to the magnetic recording head 51 according to this embodiment, stabilization of the oscillation frequency of the spin torque oscillator is realized, and the magnetic recording head by which the stable high-frequency magnetic-field assist recording can be performed can be provided.

In the magnetic recording head 51 according to this embodiment, the ways of winding the coils are set to be different between the main magnetic pole coil 61a and the adjustment magnetic pole coil 63a.

That is, the number of winding times of the main magnetic pole coil 61a can be set to be different from the number of winding times of the adjustment magnetic pole coil 63a. Thereby, even when the same current passes through the main magnetic pole coil 61a and the adjustment magnetic pole coil 63a, the intensity of the magnetic field applied to the spin torque oscillator 10 by the main magnetic pole 61 can be set to be different from the intensity of the magnetic field applied to the spin torque oscillator 10 by the adjustment magnetic pole 63. The magnetic field applied to the spin torque oscillator 10 by the main magnetic pole 61 can be anti-parallel to the magnetic field applied to the spin torque oscillator 10 by the adjustment magnetic pole 63.

The number of winding times of the main magnetic pole coil 61a and the number of winding times of the adjustment magnetic pole coil 63a can be suitably set based on, for example, characteristics of the spin torque oscillator 10, shape of the main magnetic pole coil 61a, shape of the adjustment magnetic pole 63, shape of the main magnetic pole coil 61a, position of the spin torque oscillator 10 with respect to the adjustment magnetic pole 63, and so forth.

By setting the winding direction of the main magnetic pole coil 61a to be the same as the winding direction of the adjustment magnetic pole coil 63a, the magnetic field applied to the spin torque oscillator 10 by the main magnetic pole 61 can be anti-parallel to the magnetic field applied to the spin torque oscillator 10 by the adjustment magnetic pole 63. In this case, the magnetic field applied to the spin torque oscillator 10 by the main magnetic pole 61 can be compensated by the magnetic field applied to the spin torque oscillator 10 by the adjustment magnetic pole 63, and thus, the magnetic field applied to the spin torque oscillator 10 can be smaller than the magnetic field applied to the spin torque oscillator 10 by the main magnetic pole 61. Thereby, the variation of the oscillation frequency of the spin torque oscillator 10 involved in the variation of the recording magnetic field can be effectively suppressed. That is, when the magnetic field applied to the spin torque oscillator 10 is mainly preferred to be smaller than the recording magnetic field generated by the main magnetic pole 61, this structure can be used.

The winding direction of the main magnetic pole coil 61a can be set to be the same as the winding direction of the adjustment magnetic pole coil 63a, and furthermore the number of winding times of the main magnetic pole coil 61a can be set to be different from the number of winding times of the adjustment magnetic pole coil 63a. In this case, if the oscillation frequencies of the spin torque oscillators 10 vary among the magnetic recording heads due to fluctuation of, for example, manufacturing conditions, the oscillation frequencies can be easily constant. In the same magnetic recording head, during changing the recording current among the inner circumference, the intermediate circumference and the outer circumference, the oscillation frequencies of the spin torque oscillator 10 can also be substantially constant, and thus, this is effective. As described above, the magnetic field by the main magnetic pole 61 is set to be anti-parallel to the magnetic field by the adjustment magnetic pole coil 63a in the spin torque oscillator 10, and furthermore, the intensities of the magnetic fields are set to be different, and thereby, the oscillation frequency of the spin torque oscillator 10 can be easily set to be further stably constant.

By setting the winding direction of the main magnetic pole coil 61a and the winding direction of the adjustment magnetic pole coil 63a to be reverse, the magnetic field applied to the spin torque oscillator 10 by the main magnetic pole 61 can be parallel to the magnetic field applied to the spin torque oscillator 10 by the adjustment magnetic pole 63. In this case, the magnetic field applied to the spin torque oscillator 10 by the main magnetic pole 61 can be further enhanced by the magnetic field applied to the spin torque oscillator 10 by the adjustment magnetic pole 63, and thus, the magnetic field applied to the spin torque oscillator 10 can be larger than the magnetic field applied to the spin torque oscillator 10 by the main magnetic pole 61. Thereby, the oscillation frequency of the spin torque oscillator 10 can be largely varied while suppressing the variation of the recording magnetic field. That is, when the magnetic field applied to the spin torque oscillator 10 is mainly preferred to be larger than the recording magnetic field generated by the main magnetic pole 61, this structure can be used.

For example, in such a case as the fluctuation of the oscillation frequencies among the magnetic recording heads is large, this is effective in largely varying and adjusting the oscillation frequency of the spin torque oscillator 10 by the recording current and the adjustment magnetic pole current so that the oscillation frequency of the spin torque oscillator 10 is set to accord with the resonant frequency of the magnetic recording medium.

In the above magnetic recording head 51, also in the case of varying the recording current by adjusting the numbers of winding times of the coils between the main magnetic pole coil 61a and the adjustment magnetic pole coil 63a, the variation of the magnetic field applied to the spin torque oscillator 10 was set to be small. In addition to this, the variation of the intensity of the magnetic field applied to the spin torque oscillator 10 may be set to be further smaller by using different materials for the main magnetic pole 61 and the adjustment magnetic pole 63 or by setting the yoke shapes of the main magnetic pole 61 to be different from the adjustment magnetic pole 63. Thereby, the variation of the intensity of the magnetic field applied to the spin torque oscillator 10 can be further smaller, and further stable high-frequency magnetic-field assist recording can be realized.

In the above magnetic recording head 51, as shown in FIGS. 1 and 4, the main magnetic pole coil 61a and the adjustment magnetic pole coil 63a are provided so as to surround the main magnetic pole 61 and the adjustment magnetic pole 63, respectively. However, the invention is not limited thereto.

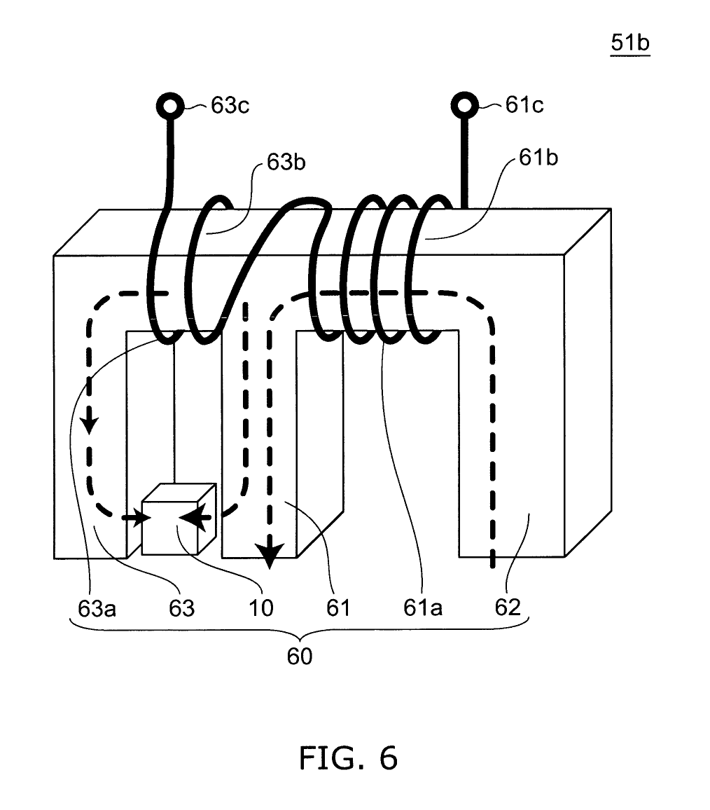

FIG. 6 is a schematic perspective view illustrating the structure of a relevant part of another magnetic recording head according to the first embodiment of the invention.

For example, as shown in FIG. 6, in another magnetic recording head 51b according to this embodiment, the main magnetic pole coil 61a is provided so as to surround the back gap portion 61b between the main magnetic pole 61 and the shield 62 (return yoke). The adjustment magnetic pole coil 63a is provided so as to surround the back gap portion 63b between the adjustment magnetic pole 63 and the shield 62 (return yoke).

In the case of the configuration in which the main magnetic pole coil 61a and the adjustment magnetic pole coil 63a are provided so as to surround the back gap portions 61b, 63b as described above, the coils can be provided in large spaces, and thus, there are advantages that a pattern width becomes large and that a large current can be easily passed.

As described above, the main magnetic pole coil 61a can be provided in the shape of at least any one of the shape surrounding the main magnetic pole 61 and the shape surrounding the back gap portion 61b between the main magnetic pole 61 and the shield 62 (return yoke). Moreover, the adjustment magnetic pole coil 63a can be provided in the shape of at least any one of the shape surrounding the adjustment magnetic pole 63 and the shape surrounding the back gap portion 63b between the adjustment magnetic pole 63 and the shield 62 (return yoke).

### Second Embodiment

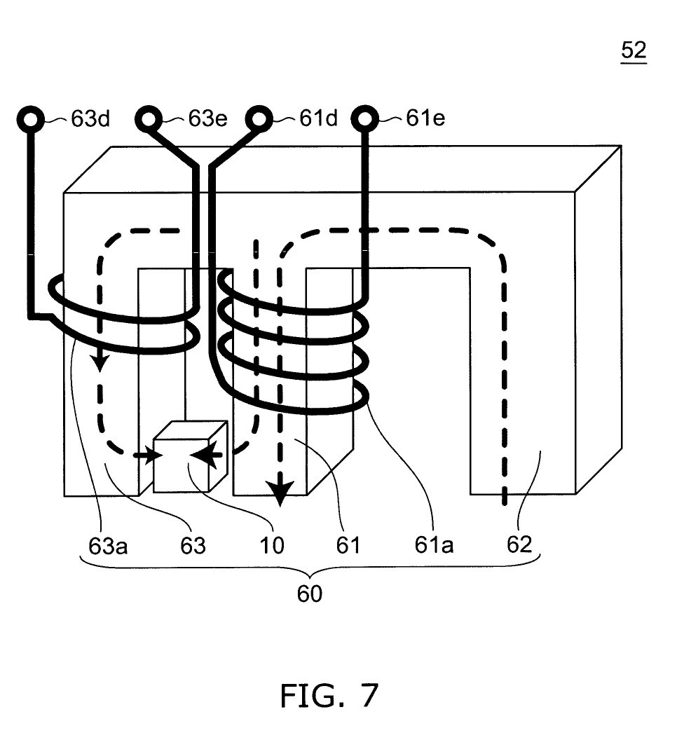

FIG. 7 is a schematic perspective view illustrating the structure of a relevant part of the magnetic head according to a second embodiment of the invention.

As shown in FIG. 7, in the writing head section 60 used in the magnetic recording head 52 according to the second embodiment of the invention, a current can be supplied to the main magnetic pole coil 61a independently of the adjustment magnetic pole coil 63a.

That is, the magnetic recording head 52 according to this embodiment has the main magnetic pole 61 for applying a recording magnetic field to the magnetic recording medium 80, the adjustment magnetic pole 63 provided in the vicinity of the main magnetic pole 61, the spin torque oscillator 10, the main magnetic pole coil 61a for magnetizing the main magnetic pole 61, and the adjustment magnetic pole coil 63a for magnetizing the adjustment magnetic pole 63. At least part of the spin torque oscillator 10 is provided between the main magnetic pole 61 and the adjustment magnetic pole 63. A current is supplied to the adjustment magnetic pole 63 independently of the main magnetic pole coil 61a.

For example, in the main magnetic pole coil 61a, a main magnetic pole coil first terminal 61d and a main magnetic pole coil second terminal 61e are provided. On the other hand, in the adjustment magnetic pole coil 63a, an adjustment magnetic pole coil first terminal 63d and an adjustment magnetic pole coil second terminal 63e are provided. One of the adjustment magnetic pole coil first terminal 63d and the adjustment magnetic pole coil second terminal 63e may double as any one of the main magnetic pole coil first terminal 61d and the main magnetic pole coil second terminal 61e.

Other than this, the magnetic recording head 52 is the same as the magnetic recording head 51 according to the first embodiment, and thus, the description thereof will be omitted.

In the magnetic recording head 52 according to this embodiment having such a structure, optional currents can be passed through the main magnetic pole coil 61a and the adjustment magnetic pole coil 63a independently.

That is, currents that are set to be different in at least any one of current value, frequency, phase, and direction of current can be passed through the main magnetic pole coil 61a and the adjustment magnetic pole coil 63a, and the oscillation frequency of the spin torque oscillator 10 can be more efficiently set to be constant by suitably adjusting the magnetic field applied to the spin torque oscillator 10 by the main magnetic pole 61 and the adjustment magnetic pole 63.

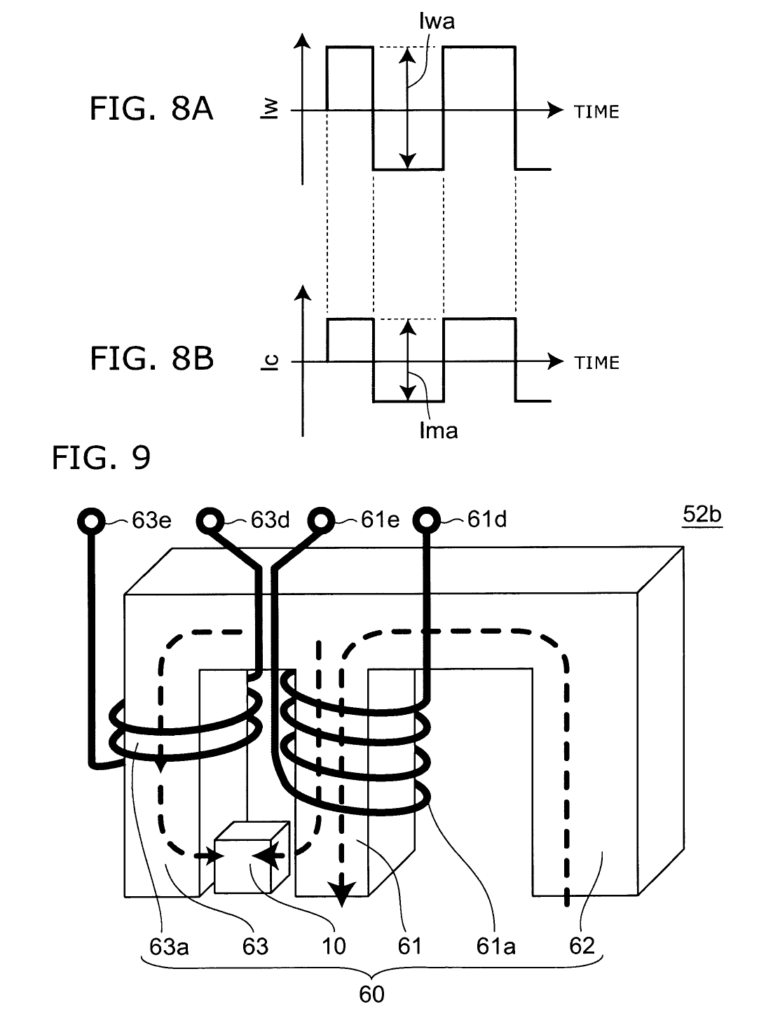

FIGS. 8A and 8B are schematic magnetic views illustrating characteristics of currents that can be used in the magnetic recording head according to the second embodiment of the invention.

That is, FIG. 8A illustrates the current passed through the main magnetic pole coil 61a in the magnetic recording head 52 according to this embodiment, namely, the recording current Iw, and the horizontal axis represents time, and the vertical axis represents the recording current Iw. FIG. 8B illustrates the adjustment magnetic pole current Ic passed through the adjustment magnetic pole coil 63a, and the horizontal axis represents time, and the vertical axis represents the adjustment magnetic pole current Ic.

As shown in FIGS. 8A and 8B, the adjustment magnetic pole current Ic can be varied in synchronization with the reversal of polarity of the recording current Iw. In this specific example, the polarity of the recording current Iw is the same as the polarity of the adjustment magnetic pole current Ic. That is, the recording current Iw and the adjustment magnetic pole current Ic have the same phases.

In the magnetic recording head 52 according to this embodiment, because the winding direction of the main magnetic pole coil 61a is the same as the winding direction of the adjustment magnetic pole coil 63a, by setting the polarity of the recording current Iw to be the same as the polarity of the adjustment magnetic pole current Ic, the magnetic fields applied to the spin torque oscillator 10 by the main magnetic pole 61 can be set to be anti-parallel to the adjustment magnetic pole 63.

As shown in FIGS. 8A and 8B, the amplitude Ica (that may be a current value) of the adjustment magnetic pole current Ic is different from the amplitude Iwa (that may be a current value) of the recording current Iw. As described above, the amplitude Ica (that may be a current value) of the adjustment magnetic pole current Ic can be variable independently of the amplitude Iwa (that may be a current value) of the recording current Iw.

The adjustment magnetic pole current Ic is adjusted independently of the recording current Iw so that the oscillation frequency of the spin torque oscillation 10 is constant.

The magnetic field of the total of the magnetic fields applied to the spin torque oscillator 10 by the main magnetic pole 61 and the adjustment magnetic pole 63 can be smaller than the intensity of the magnetic field applied to the spin torque oscillator 10 by the main magnetic pole 61.

Thereby, the variation of the magnetic field of the total of the magnetic fields applied to the spin torque oscillator 10 by the main magnetic pole 61 and the adjustment magnetic pole 63 can be smaller than the variation of the magnetic field applied by the main magnetic pole 61 to the spin torque oscillator 10. Thus, the oscillation frequency of the spin torque oscillator 10 can be efficiently maintained to be substantially constant.

For example, in the magnetic recording head 52, in the case where the oscillation frequency of the spin torque oscillator 10 varies due to the fluctuation of the manufacturing conditions or the like, the current of the adjustment magnetic pole coil 63a can be adjusted independently of the main magnetic pole coil 61a according to characteristic of each of the magnetic recording heads 52, and therefore, the fluctuation of the oscillation frequency of the spin torque oscillator 10 can be reduced and uniformized.

As described above, according to the magnetic recording head 52 according to this embodiment, stabilization and uniformization of the oscillation frequency of the spin torque oscillator is realized, and the magnetic recording head by which the stable high-frequency magnetic-field assist recording can be performed can be provided.

FIG. 9 is a schematic perspective view illustrating the structure of a relevant part of another magnetic recording head according to the second embodiment of the invention.

As shown in FIG. 9, in the writing head section 60 used for another magnetic recording head 52b according to the second embodiment of the invention, the main magnetic pole coil 61a and the adjustment magnetic pole coil 63a are provided with terminals to which currents can be independently supplied. And, the winding direction of the main magnetic pole coil 61a and the winding direction of the adjustment magnetic pole coil 63a are reverse. That is, in the magnetic recording head 52, the ways of winding of the main magnetic pole coil 61a and the adjustment magnetic pole coil 63a are reversed to each other. Other than this, the magnetic recording head 52b is the same as the magnetic recording head 52, and thus, the description thereof will be omitted.

In the case of this structure, when the currents having reversed phases (reversed polarities) are passed, the magnetic field applied to the spin torque oscillator 10 by the main magnetic pole 61 and the magnetic field applied to the spin torque oscillator 10 by the adjustment magnetic pole 63 are anti-parallel to each other.

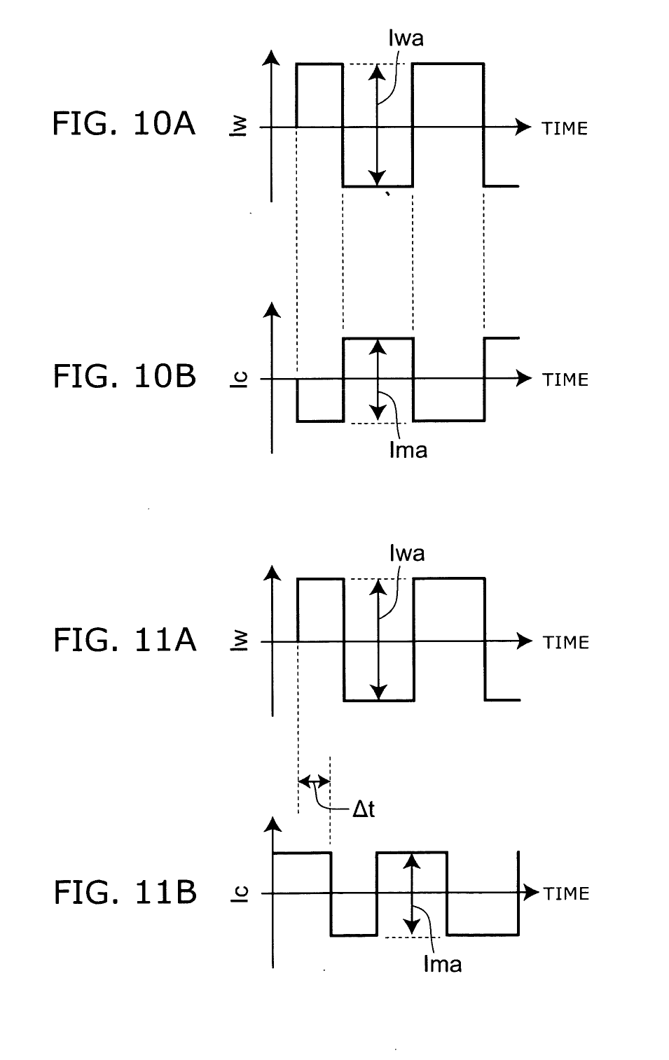

FIGS. 10A and 10B are schematic views illustrating characteristics of the current that can be used in another magnetic recording head according to the second embodiment of the invention.

That is, FIG. 10A illustrates the current passed through the main magnetic pole coil 61a in the magnetic recording head 52b according to this embodiment, namely, the recording current Iw, and the horizontal axis represents time, and the vertical axis represents the recording current Iw. FIG. 10B illustrates the adjustment magnetic pole current Ic passed through the adjustment magnetic pole coil 63a, and the horizontal axis represents time, and the vertical axis represents the adjustment magnetic pole current Ic.

As shown in FIGS. 10A and 10B, the adjustment magnetic pole current Ic can be varied in synchronization with the reversal of polarity of the recording current Iw. In this specific example, the polarity of the recording current Iw and the polarity of the adjustment magnetic pole current Ic are reverse. That is, the recording current Iw and the adjustment magnetic pole current Ic have the reversed phases.

Thereby, in the magnetic recording head 52b according to this embodiment, the magnetic fields applied to the spin torque oscillator 10 by the main magnetic pole 61 and the adjustment magnetic pole 63 are anti-parallel.

As shown in FIGS. 10A and 10B, the amplitude Iwa (that may be a current value) of the recording current Iw and the amplitude Ica (that may be a current value) of the adjustment magnetic pole current Ic can be variable independently.

The adjustment magnetic pole current Ic is adjusted independently of the recording current Iw so that the oscillation frequency of the spin torque oscillation 10 is constant.

The magnetic field of the total of the magnetic fields applied to the spin torque oscillator by the main magnetic pole 61 and the adjustment magnetic pole 63 can be smaller than the intensity of the magnetic field applied to the spin torque oscillator 10 by the main magnetic pole 61.

Thereby, the variation of the magnetic field of the total of the magnetic fields applied to the spin torque oscillator 10 by the main magnetic pole 61 and the adjustment magnetic pole 63 can be smaller than the variation of the magnetic field applied by the main magnetic pole 61 to the spin torque oscillator 10. Thus, the oscillation frequency of the spin torque oscillator 10 can be efficiently maintained to be substantially constant.

As described above, according to another magnetic recording head 52b according to this embodiment, stabilization and uniformization of the oscillation frequency of the spin torque oscillator is realized, and the magnetic recording head by which the stable high-frequency magnetic-field assist recording can be performed can be provided.

The recording current Iw and the adjustment magnetic pole current Ic having reversed phases as illustrated in FIGS. 10A and 10B may be passed through the magnetic recording head 52 in which the winding directions of the main magnetic pole coil 61a and the adjustment magnetic pole coil 63a are the same as illustrated in FIG. 7, respectively. Thus, the adjustment magnetic pole current Ic is adjusted independently of the recording current Iw so that the oscillation frequency of the spin torque oscillation 10 is constant. Thereby, for example, the magnetic field of the total of the magnetic fields applied to the spin torque oscillator by the main magnetic pole 61 and the adjustment magnetic pole 63 can be larger than the intensity of the magnetic field applied to the spin torque oscillator 10 by the main magnetic pole 61.

Thereby, the variation of the magnetic field of the total of the magnetic fields applied to the spin torque oscillator 10 by the main magnetic pole 61 and the adjustment magnetic pole 63 can be smaller than the variation of the magnetic field applied by the main magnetic pole 61 to the spin torque oscillator 10. Thus, the oscillation frequency of the spin torque oscillator 10 can be efficiently maintained to be substantially constant.

Similarly, the recording current Iw and the adjustment magnetic pole current Ic having the same phases as illustrated in FIGS. 8A and 8B may be passed through the magnetic recording head 52b in which the winding directions of the main magnetic pole coil 61a and the adjustment magnetic pole coil 63a are reverse as illustrated in FIG. 9, respectively. Thereby, the adjustment magnetic pole current Ic is adjusted independently of the recording current Iw so that the oscillation frequency of the spin torque oscillation 10 is constant. Thus, for example, the magnetic field of the total of the magnetic fields applied to the spin torque oscillator by the main magnetic pole 61 and the adjustment magnetic pole 63 can be larger than the intensity of the magnetic field applied to the spin torque oscillator 10 by the main magnetic pole 61.

Thereby, the change of the magnetic field of the total of the magnetic fields applied to the spin torque oscillator 10 from the main magnetic pole 61 and the adjustment magnetic pole 63 can be smaller than the change of the magnetic field applied from the main magnetic pole 61 to the spin torque oscillator 10. Thereby, the oscillation frequency of the spin torque oscillator 10 can be efficiently maintained to be substantially constant.

FIGS. 11A and 11B are schematic magnetic views illustrating characteristics of currents that can be used in the magnetic recording head according to the second embodiment of the invention.

As shown in FIGS. 11A and 11B, for another current that can be used in the magnetic recording head 52b according to this embodiment, phases of the recording current Iw by the main magnetic pole 61 and the adjustment magnetic pole current Ic are shifted by a predetermined time Δt.

By adjusting the Δt, the direction of the magnetic field applied to the spin torque oscillator 10 by the main magnetic pole 61 and the direction of the magnetic field applied to the spin torque oscillator 10 by the adjustment magnetic pole 63 can be parallel or anti-parallel to each other.

It can be in the state in which the magnetic field applied to the spin torque oscillator 10 by the main magnetic pole 61 and the magnetic field applied to the spin torque oscillator 10 by the adjustment magnetic pole 63 enhance each other or weaken each other.

Thereby, the overall intensity of the magnetic field applied to the spin torque oscillator 10 by the main magnetic pole 61 and the adjustment magnetic pole 63 can be easily set to be larger or smaller than the intensity of the magnetic field applied to the spin torque oscillator 10 by the main magnetic pole 61. The variation of the overall intensity of the magnetic field applied to the spin torque oscillator 10 by the main magnetic pole 61 and the adjustment magnetic pole 63 can be smaller than the variation of the magnetic field applied by the main magnetic pole 61 to the spin torque oscillator 10 when the recording magnetic field of the main magnetic pole 61 is varied. Thus, the oscillation frequency of the spin torque oscillator 10 can be efficiently maintained to be substantially constant.

In the case where the adjustment magnetic pole current Ic is varied in synchronization with the reversal of polarity of the recording current Iw, namely, in the case where Δt is zero, occasionally, the time until the oscillation frequency of the spin torque oscillator 10 reaches a certain value becomes longer than the time required for the reversal of polarity of the recording current Iw. In such a case, it is effective to delay the phase of the adjustment magnetic pole current Ic by the predetermined time Δt with respect to the recording current Iw. That is, in the period of Δt from the reversal of the recording current Iw, the magnetic field applied by the adjustment magnetic pole 63 to the spin torque oscillator 10 and the magnetic field applied by the main magnetic pole 61 to the spin torque oscillator 10 enhance each other. Thus, reversal of the oscillation state of the spin torque oscillator 10 becomes more rapid. As a result, the apparatus by which the stable and high-quality high-frequency magnetic-field assist recording can be performed can be realized.

The recording current Iw and the adjustment magnetic pole current Ic whose phases are shifted by Δt as illustrated in FIG. 11 may be passed through the magnetic recording head 52 in which winding directions of the main magnetic pole coil 61a and the adjustment magnetic pole coil 63a are the same as illustrated in FIG. 7, respectively.

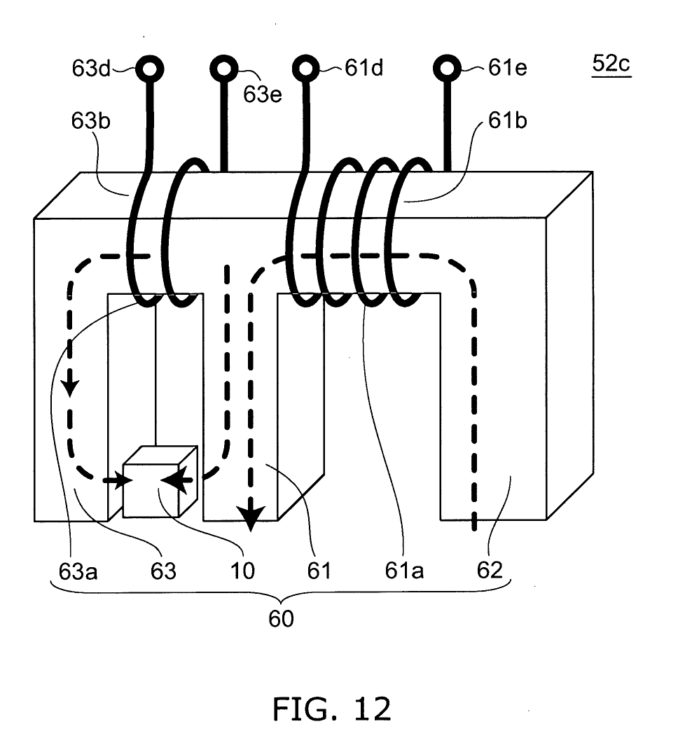

FIG. 12 is a schematic perspective view illustrating the structure of a relevant part of another magnetic recording head according to the second embodiment of the invention.

As shown in FIG. 12, in another magnetic recording head 52c according to this embodiment, the main magnetic pole coil 61a is provided so as to surround the back gap portion 61b between the main magnetic pole 61 and the shield 62 (return yoke). The adjustment magnetic pole coil 63a is provided so as to surround the back gap portion 63b between the adjustment magnetic pole 63 and the shield 62 (return yoke). The main magnetic pole coil 61a and the adjustment magnetic pole coil 63a are provided with the terminals to which currents can be supplied independently, namely, the main magnetic pole coil first terminal 61d, the main magnetic pole coil second terminal 61e, the adjustment magnetic pole coil first terminal 63d, and the adjustment magnetic pole coil second terminal 63e.

In the case of the configuration where the main magnetic pole coil 61a and the adjustment magnetic pole coil 63a are provided so as to surround the back gap portions 61b, 63b as described above, the coils can be provided in large spaces, and thus, there are advantages that a pattern width becomes large and that large currents can be easily passed.

Furthermore, by providing the main magnetic pole coil 61a and the adjustment magnetic pole coil 63a with the terminals to which currents can be supplied independently, the oscillation frequency of the spin torque oscillator 10 can be more efficiently constant.

In this structure, the numbers of winding times of the main magnetic pole coil 61a can be set to be different from the adjustment magnetic pole coil 63a. The winding directions of the main magnetic pole coil 61a and the adjustment magnetic pole coil 63a can be the same directions or the reversed directions.

### Third Embodiment

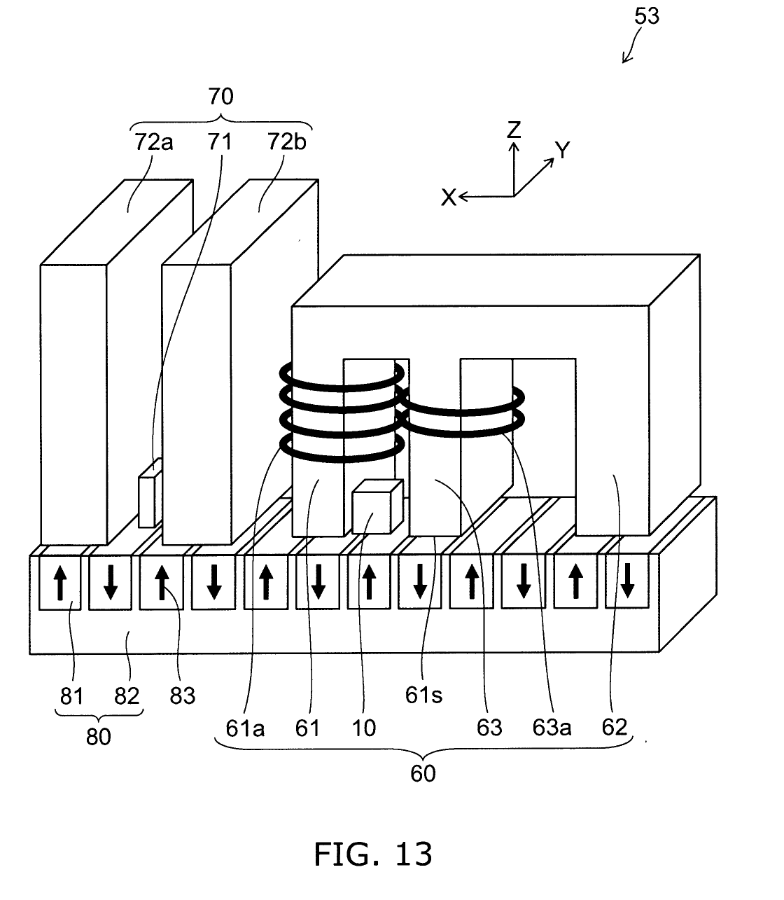

FIG. 13 is a schematic perspective view illustrating the structure of a relevant part of the magnetic recording head according to a third embodiment of the invention.

As shown in FIG. 13, in the magnetic recording head 53 according to the third embodiment of the invention, the relative positions of the main magnetic pole 61 and the adjustment magnetic pole 63 in the writing head section 60 are reversed, compared to the magnetic recording head 51 illustrated in FIG. 1. That is, the main magnetic pole 61 is disposed at the far position from the return path 62 of the writing head section 60, and the adjustment magnetic pole 63 is provided between the main magnetic pole 61 and the return path 62. Other than this, the magnetic recording head 53 is the same as the magnetic recording head 51. That is, the spin torque oscillator 10 is disposed between the main magnetic pole 61 and the adjustment magnetic pole 63, and the reproducing head section 70 is disposed on the opposite side to the return path 62 of the main magnetic pole 61. The main magnetic pole coil 61a for magnetizing the main magnetic pole 61 and the adjustment magnetic pole coil 63a for magnetizing the adjustment magnetic pole 63 are provided.

Also in this case, the ways of winding, namely, at least any one of the number of winding times and the winding direction can be set to be different between the main magnetic pole coil 61a and the adjustment magnetic pole coil 63a. In this case, the main magnetic pole coil 61a can be serially connected to the adjustment magnetic pole coil 63a. A current can be supplied to the main magnetic pole coil 61a independently of the adjustment magnetic pole coil 63a. For example, terminals to which currents can be independently supplied can be provided.

Thereby, also in the magnetic recording head 53 according to this embodiment, even when the recording current is varied, the variation of the magnetic field applied to the spin torque oscillator 10 can be small, and thus, the oscillation frequency of the spin torque oscillator 10 can be maintained to be substantially constant.

As described above, according to the magnetic recording head 53 according to this embodiment, stabilization and uniformization of the oscillation frequency of the spin torque oscillator is realized, and the magnetic recording head by which the stable high-frequency magnetic-field assist recording can be performed can be provided.

In the case of the magnetic recording head 53 illustrated in FIG. 13, recording and reading can be performed with relatively moving of the magnetic recording medium 80 with respect to the magnetic recording head 53. That is, a particular place of the magnetic recording medium 80 is sequentially opposed to the return path 62, the adjustment magnetic pole 63, the spin torque oscillator 10, the main magnetic pole 61, and the reproducing head section 70, respectively. And, on the magnetic recording medium 80, writing is performed in the superposed region of the recording magnetic field by the main magnetic pole 61 and the high-frequency magnetic field by the spin torque oscillator 10. Therefore, even if the magnetic recording medium 80 receives an unintended influence by the magnetic field by the adjustment magnetic pole 63, this is overwritten to be in a normal state by the recording magnetic field and the high-frequency magnetic field by the spin torque oscillator 10 and the main magnetic pole 61 to be opposed after the adjustment magnetic pole 63. Thereby, further stable magnetic recording can be performed.

On the other hand, in the magnetic recording head 51 illustrated in FIG. 1, a particular place of the magnetic recording medium 80 is sequentially opposed to the return path 62, the main magnetic pole 61, the spin torque oscillator 10, the adjustment magnetic pole 63, and the reproducing head section 70, respectively. Therefore, after writing is performed by the recording magnetic field and the high-frequency magnetic field by the spin torque oscillator 10 and the main magnetic pole 61, the magnetic recording medium 80 is opposed to the adjustment magnetic pole 63. In this case, it is likely that the magnetic recording medium 80 receives an unintended influence by the magnetic field by the adjustment magnetic pole 63 and that the state in which writing is once performed is adversely affected. However, because the magnetic field by the adjustment magnetic pole 63 to the magnetic recording medium 80 can be set to be smaller and thereby the influence of the adjustment magnetic pole 63 on the magnetic recording medium 80 can be made to be as small as substantially ignorable, this problem is solved. In addition to the technique of setting the current of the adjustment magnetic pole coil 63a to be small, by such a technique as enlarging the distance between the adjustment magnetic pole 63 and the magnetic recording medium 80 in comparison to the distance between the main magnetic pole 61 and the magnetic recording medium 80, the influence of the adjustment magnetic pole 63 on the magnetic recording medium 80 can be made to be as small as substantially ignorable.

As described above, as shown in FIGS. 1 and 13, in either case of the relative position relations between the main magnetic pole 61 and the adjustment magnetic pole 63, the oscillation frequency of the spin torque oscillator 10 can be constant.

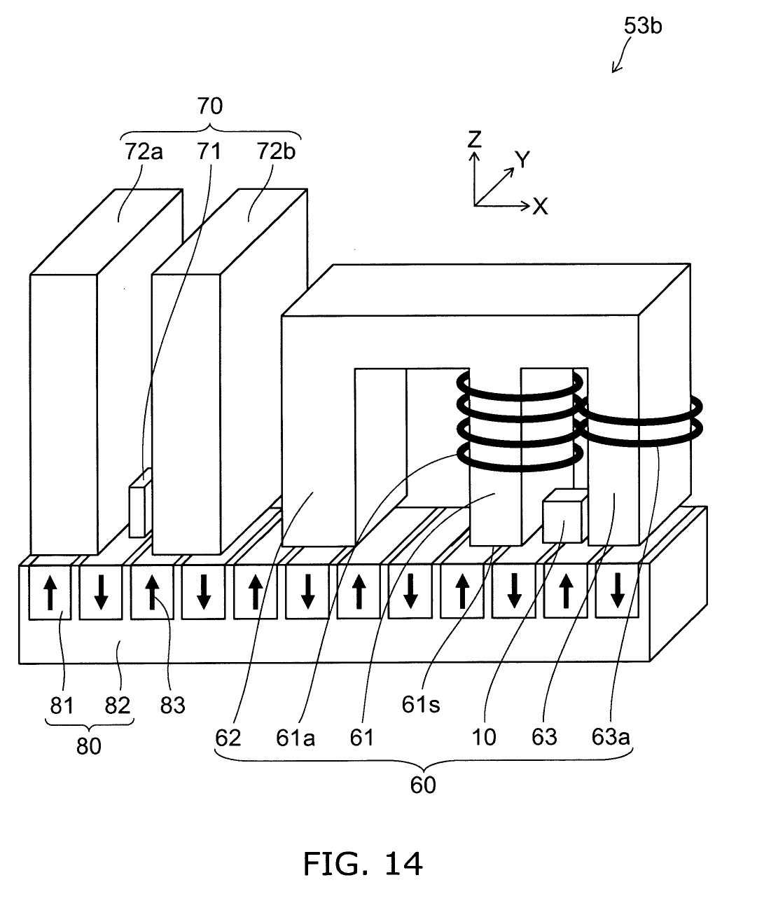

FIG. 14 is a schematic perspective view illustrating the structure of a relevant part of another magnetic recording head according to the third embodiment of the invention.

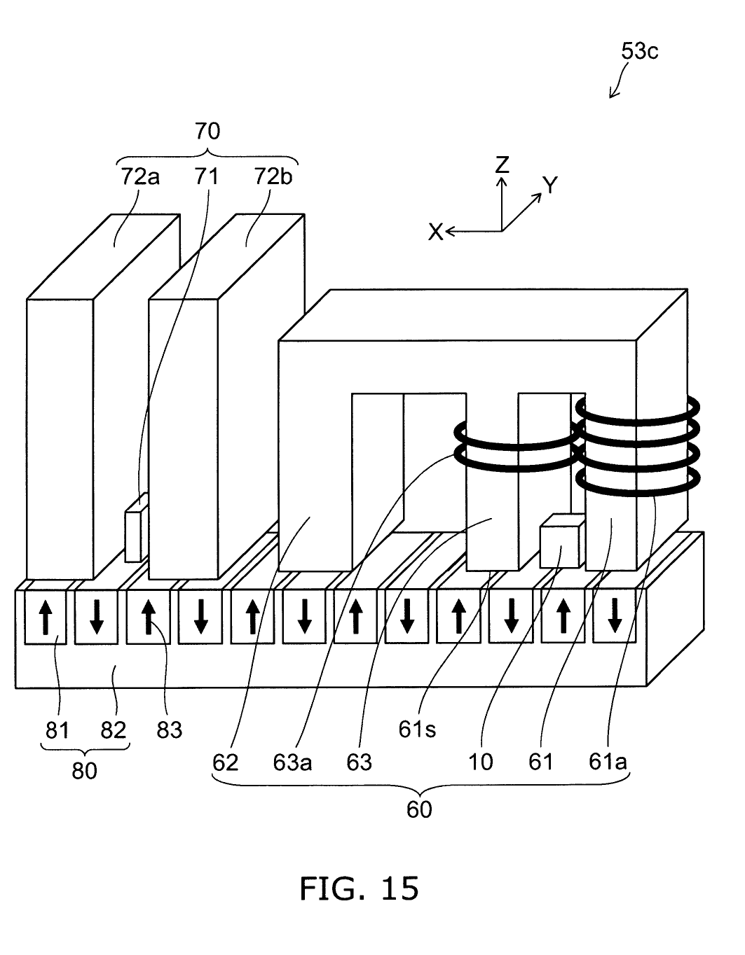

FIG. 15 is a schematic perspective view illustrating the structure of a relevant part of another magnetic recording head according to the third embodiment of the invention.

As shown in FIG. 14, another magnetic recording head 53b according to this embodiment has a configuration in which the return path 62 is provided between the reproducing head section 70 and the adjustment magnetic pole 63 and the main magnetic pole 61 is provided between the adjustment magnetic pole 63 and the return path 62. In this structure, the spin torque oscillator 10 is also provided between the main magnetic pole 61 and the adjustment magnetic pole 63.

As shown in FIG. 15, another magnetic recording head 53c according to this embodiment has a configuration in which the return path 62 is provided between the reproducing head section 70 and the main magnetic pole 61 and the adjustment magnetic pole 63 is provided between the main magnetic pole 61 and the return path 62. In this structure, the spin torque oscillator 10 is also provided between the main magnetic pole 61 and the adjustment magnetic pole 63.

Also in the above magnetic recording heads 53b, 53c, the ways of winding, namely, at least any one of the number of winding times and the winding direction can be set to be different between the main magnetic pole coil 61a and the adjustment magnetic pole coil 63a. In this case, the main magnetic pole coil 61a can be serially connected to the adjustment magnetic pole coil 63a. A current can be supplied to the main magnetic pole coil 61a independently of the adjustment magnetic pole coil 63a. For example, terminals to which currents can be independently supplied can be provided.

Also in the above magnetic recording heads 53b, 53c having such configurations, even when the recording current is varied, the variation of the magnetic field applied to the spin torque oscillator 10 can be reduced by the magnetic field by the adjustment magnetic pole 63, and thereby, the oscillation frequency of the spin torque oscillator 10 can be maintained to be substantially constant.

As described above, also according to other magnetic recording heads 53b, 53c according to this embodiment, stabilization and uniformization of the oscillation frequency of the spin torque oscillator is realized, and the magnetic recording head by which the stable high-frequency magnetic-field assist recording can be performed can be provided.

In general, the magnetic pole nearer to the return path 62 has a stronger magnetic field than the far magnetic pole, and thus, the magnetic recording head 51 illustrated in FIG. 1 and the magnetic recording head 53b illustrated in FIG. 14 in which the distance between the return path 62 and the main magnetic pole 61 is shorter than the distance between the return path 62 and the adjustment magnetic pole 63 are preferable to the magnetic recording head 53 illustrated in FIG. 13 and the magnetic recording head 53c illustrated in FIG. 15.

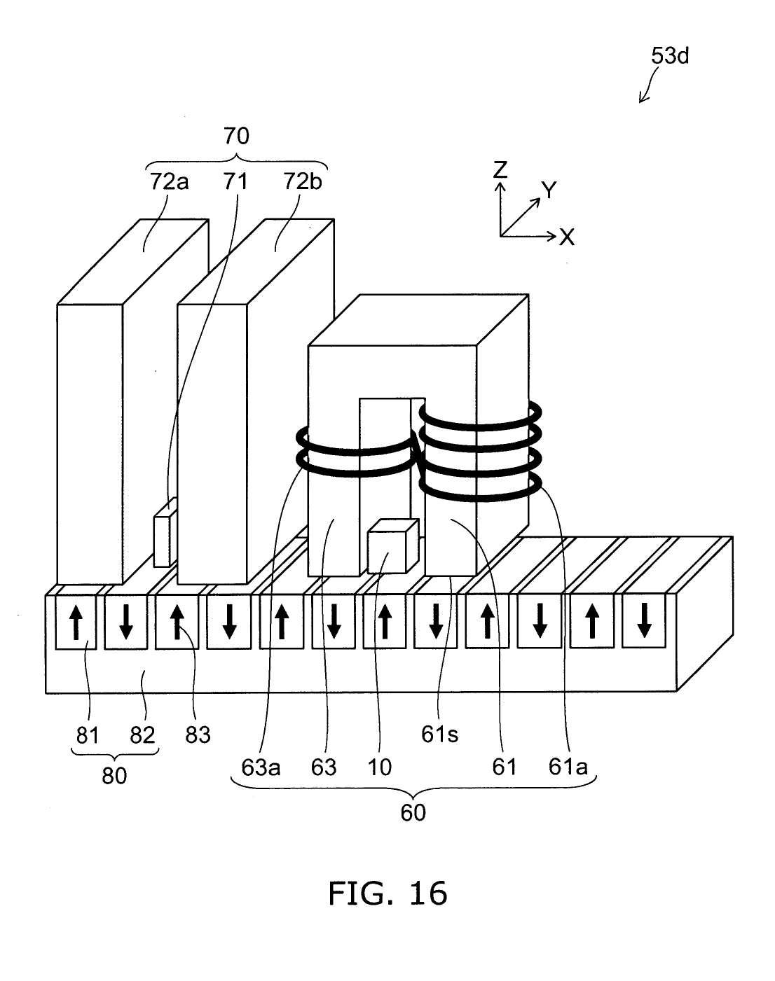

FIG. 16 is a schematic perspective view illustrating the structure of a relevant part of another magnetic recording head according to the third embodiment of the invention.

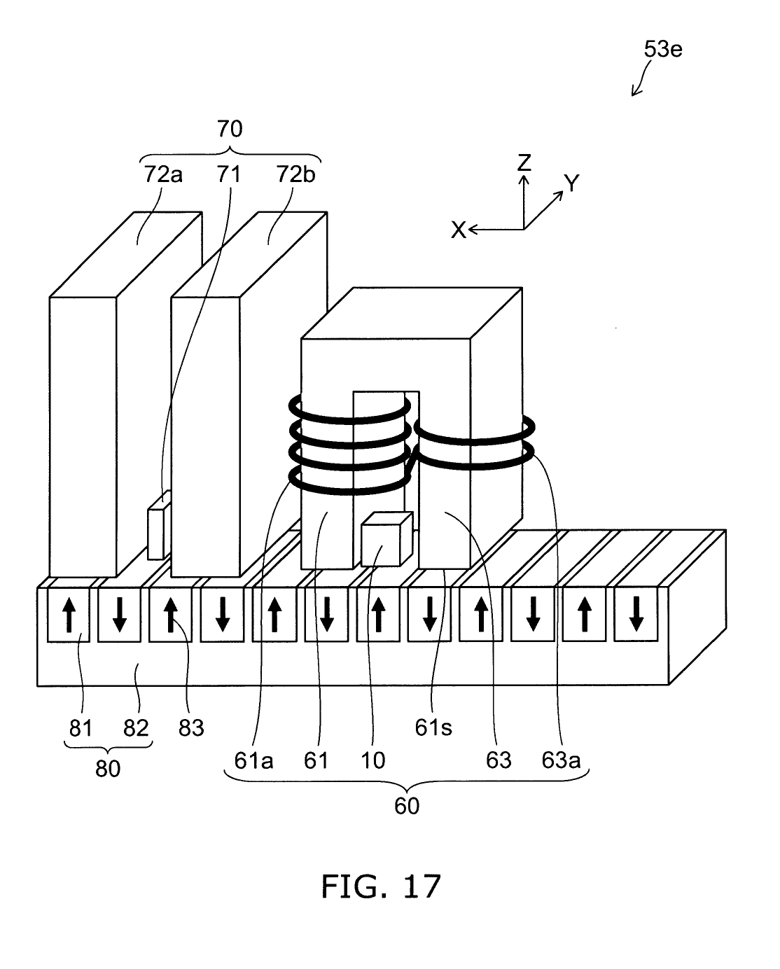

FIG. 17 is a schematic perspective view illustrating the structure of a relevant part of another magnetic recording head according to the third embodiment of the invention.

As shown in FIGS. 16, 17, in other magnetic recording heads 53d, 53e according to this embodiment, the return path is omitted in the magnetic recording head 51 illustrated in FIG. 1 and the magnetic recording head 53 illustrated in FIG. 13.

Also in the above magnetic recording heads 53d, 53e, the ways of winding, namely, at least any one of the number of winding times and the winding direction can be set to be different between the main magnetic pole coil 61a and the adjustment magnetic pole coil 63a. In this case, the main magnetic pole coil 61a can be serially connected to the adjustment magnetic pole coil 63a. A current can be supplied to the main magnetic pole coil 61a independently of the adjustment magnetic pole coil 63a. For example, terminals to which currents can be independently supplied can be provided.

Also in the magnetic recording heads 53d, 53e in which the return path is omitted as described above, even when the recording current is varied, the variation of the magnetic field applied to the spin torque oscillator 10 can be reduced by the magnetic field by the adjustment magnetic pole 63, and thereby, the oscillation frequency of the spin torque oscillator 10 can be maintained to be substantially constant.

As described above, also in other magnetic recording heads 53d, 53e according to this embodiment, stabilization and uniformization of the oscillation frequency of the spin torque oscillator is realized, and the magnetic recording head by which the stable high-frequency magnetic-field assist recording can be performed can be provided.

Also in the above magnetic recording heads 53, 53b to 53e, the main magnetic pole coil 61a can be provided in the shape of at least any one of the shape surrounding the main magnetic pole 61 and the shape surrounding the back gap portion 61b between the main magnetic pole 61 and the shield 62 (return yoke). The adjustment magnetic pole coil 63a can be provided in the shape of at least any one of the shape surrounding the adjustment magnetic pole 63 and the shape surrounding the back gap portion 63b between the adjustment magnetic pole 63 and the shield 62 (return yoke).

### Fourth Embodiment

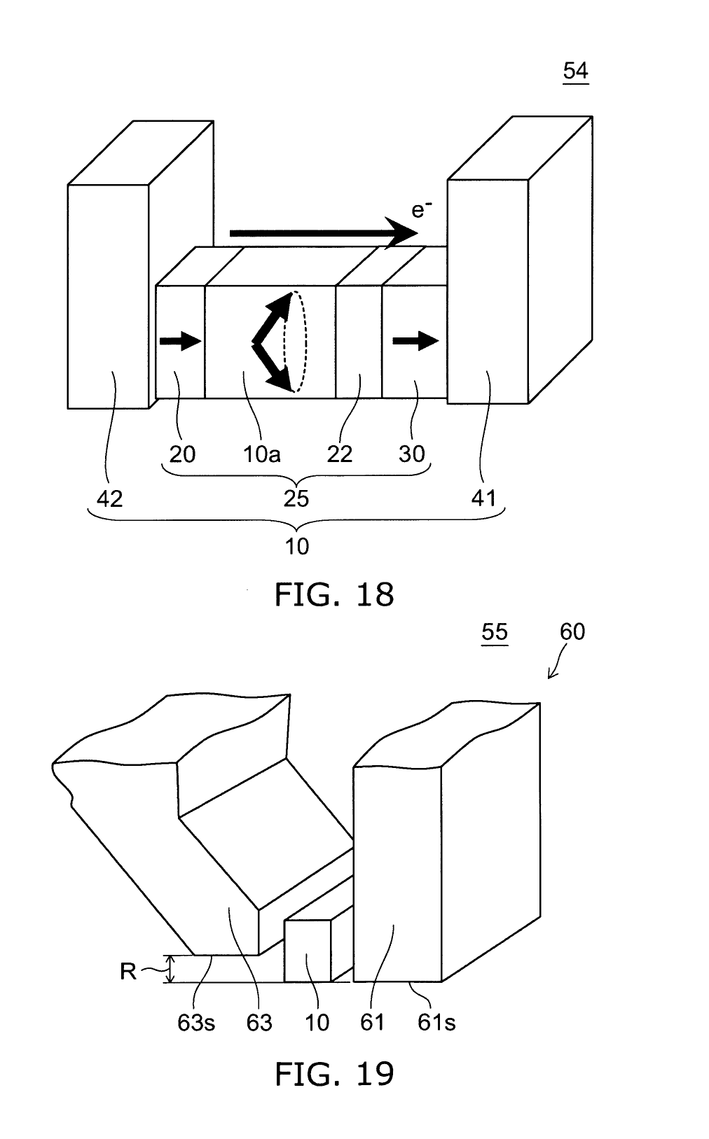

FIG. 18 is a schematic perspective view illustrating the structure of the spin torque oscillator used in the magnetic recording head according to a fourth embodiment of the invention.

As shown in FIG. 18, in the magnetic recording head 54 according to the fourth embodiment of the invention, a bias layer 20 is provided between the second electrode 42 and the oscillation layer 10a of the spin torque oscillator 10.

That is, the stacked body 25 of the spin torque oscillator 10 further includes a third magnetic layer (bias layer) provided on the opposite side to the intermediate layer 22 of the oscillation layer 10a and having a smaller coercivity than the magnetic field applied from the main magnetic pole 61.

Other than this, the magnetic recording head 54 can have the same structure as, for example, the magnetic recording head 51 illustrated in FIG. 1, the description thereof will be omitted.

The bias layer 20 can be illustratively made of a CoPt alloy layer, and can provide bias to the oscillation layer 10a by the exchange coupling force.

Thereby, even if the magnetic fields applied to the spin torque oscillator 10 by the main magnetic pole 61 and the adjustment magnetic pole 63 are anti-parallel to each other and the magnetic-field intensities become quite the same, namely, even when the magnetic-field intensity in the spin torque oscillator 10 becomes zero, the spin torque oscillator 10 can oscillate stably in a predetermined frequency.

Thereby, for example, even when the shapes of the main magnetic pole 61 and the adjustment magnetic pole 63 are analogous and the numbers of winding times of the main magnetic pole coil 61a and the adjustment magnetic pole coil 63a are slightly different, the spin torque oscillator 10 can stably oscillate.

As described above, by using the spin torque oscillator 10 provided with the bias layer 20, more stable oscillation can be realized, and by another magnetic recording head 54 according to this embodiment, the oscillation frequency of the spin torque oscillator 10 is more stabilized and more uniformized, and thereby, the magnetic recording head by which the stable high-frequency magnetic field assist recording can be performed can be provided.

### Fifth Embodiment

FIG. 19 is a schematic perspective view illustrating the structure of a relevant part of the magnetic recording head according to a fifth embodiment of the invention.

As shown in FIG. 19, in the magnetic recording head 55 according to the fifth embodiment of the invention, an end face 63s of the air bearing surface 61s side of the adjustment magnetic pole 63 is recessed from the air bearing surface 61s of the main magnetic pole 61. Other than this, the magnetic recording head 55 can be the same as the magnetic recording head 51 illustrated in FIGS. 1 to 4, and thus, the description thereof will be omitted.

That is, in the magnetic recording head 55 according to this embodiment, the surface 63s of the adjustment magnetic pole 63 is disposed above the air bearing surface 61s of the main magnetic pole 61, and thereby, the distance between the surface 63s of the air bearing surface 61s of the adjustment magnetic pole 63 and the magnetic recording medium 80 is longer than the distance between the air bearing surface 61s of the main magnetic pole 61 and the magnetic recording medium 80, by the distance R.

Thereby, without substantially affecting the magnetic field provided to the spin torque oscillator 10 by the adjustment magnetic pole 63, the influence exerted by the adjustment magnetic pole 63 on the magnetic recording medium 80 can be reduced. Thereby, the adjustment magnetic pole 63 can efficiently apply an appropriate magnetic field to the spin torque oscillator 10. Thereby, the oscillation frequency of the spin torque oscillator 10 can be more efficiently set to be constant.

The surface of the magnetic recording medium 80 side of the spin torque oscillator 10 can be set to in the plane parallel to the air bearing surface 61s of the main magnetic pole 61. That is, the spin torque oscillator 10 is not disposed to be recessed like the adjustment magnetic pole 63 but can be disposed to be adjacent to the magnetic recording medium 80 similarly to the main magnetic pole 61. Thereby, the recording magnetic field from the main magnetic pole 61 and the high-frequency magnetic field from the spin torque oscillator 10 are efficiently applied to the magnetic recording medium 80, and efficient magnetic recording can be performed.

In the magnetic recording head 55 according to this embodiment, the main magnetic pole coil 61a and the adjustment magnetic pole coil 63a are serially connected like the magnetic recording head 51 illustrated in FIG. 4, and the number of winding times of the main magnetic pole coil 61a and the number of winding times of the adjustment magnetic pole coil 63a can be changed. However, the invention is not limited thereto, and the configuration in which a current can be supplied to the main magnetic pole coil 61a independently of the adjustment magnetic pole coil 63a like the magnetic recording head 52 illustrated in FIG. 7 is also possible. Furthermore, this can be applied to all of the magnetic recording heads described above.

In the magnetic recording head 55 according to this embodiment, by recessing the adjustment magnetic pole 63 from the main magnetic pole 61, the magnetic field of the adjustment magnetic pole 63 can be efficiently applied to the spin torque oscillator 10, and therefore, the number of winding times of the adjustment magnetic pole coil 63a can be reduced. In this case, in the case of the structure in which the main magnetic pole coil 61a is serially connected to the adjustment magnetic pole coil 63a, the electric resistance in the main magnetic pole coil 61a and the adjustment magnetic pole coil 63a can be reduced, and there is an advantage that the recording current provided to the main magnetic pole 61 can be easily controlled.

As shown in FIG. 19, the adjustment magnetic pole 63 can have the shape of being adjacent to the spin torque oscillator 10, namely, adjacent to the main magnetic pole 61 in the part of the spin torque oscillator 10 side and being separate from the main magnetic pole 61 above the spin torque oscillator 10. By the structure, in only the adjacent region to the spin torque oscillator 10, the spin torque oscillator 10 and the adjustment magnetic pole 63 can be approximated, and the magnetic field of the adjustment magnetic pole 63 can be efficiently applied to the spin torque oscillator 10, and tolerance of the driving condition becomes large, and the magnetic recording head that can be easily produced can be obtained.

### Sixth Embodiment

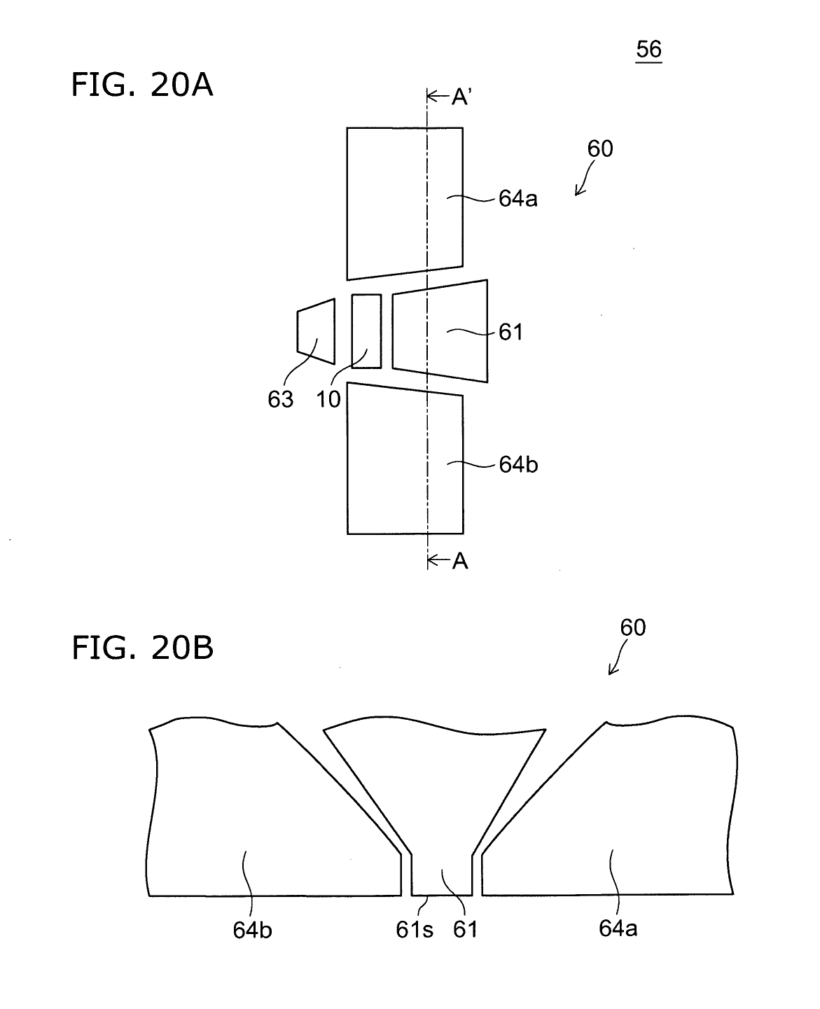

FIGS. 20A and 20B are schematic views illustrating the structure of a relevant part of the magnetic recording head according to a sixth embodiment of the invention.

That is, FIG. 20A is a plan view illustrating the structure of the writing head section 60 in the air bearing surface 61s side, and FIG. 20B is a cross- sectional view taken along line A-A′ of FIG. 20A.

As shown in FIGS. 20A, 20B, in the magnetic recording head 56 according to the sixth embodiment of the invention, the side shields 64a, 64b are provided in the side surfaces of the main magnetic pole 61 and the spin torque oscillator 10. That is, the magnetic recording head 56 further includes the side shields 64a, 64b provided to be opposed to the side surfaces of at least any one of the main magnetic pole 61 and the spin torque oscillator 10 (namely, the surface that is perpendicular to the direction in which the main magnetic pole 61 and the spin torque oscillator 10 are arranged and that is different from the air bearing surface 80 of the main magnetic pole 61). Other than this, the magnetic recording head 56 can be the same as the magnetic recording head 51 illustrated in FIGS. 1 to 4, and thus, the description thereof will be omitted.

In the magnetic recording head 56 according to this embodiment, the side shield 64a, 64b provided in the side surfaces of the main magnetic pole 61 and the spin torque oscillator 10 can suppress spread of the recording magnetic field from the main magnetic pole 61 to the adjacent track of the magnetic recording medium 80 and spread of the high-frequency magnetic field from the spin torque oscillator 10.

Thereby, the recording magnetic field from the main magnetic pole 61 superposes on the high-frequency magnetic field from the spin torque oscillator 10, and the region in which the high-frequency magnetic-field assist recording can be performed concentrates on the gap portion between the main magnetic pole 61 and the spin torque oscillator 10. As a result, recording concentrating on only the desired track becomes possible, and thus more efficient recording becomes possible. Accordingly, recording with higher-recording-density becomes possible.

As illustrated in FIG. 20B, the distance between the side shield 64a, 64b and the main magnetic pole 61 can be set to be short in the vicinity of the air bearing surface 61s of the main magnetic pole 61 and can be set to be long in the far portion from the air bearing surface 61s. Thereby, in the vicinity of the air bearing surface 61s, the recording magnetic field of the main magnetic pole 61 can be more efficiently concentrated to be effective.

In the magnetic recording head 56 according to this embodiment, the main magnetic pole coil 61a is serially connected to the adjustment magnetic pole coil 63a like the magnetic recording head 51 illustrated in FIG. 4, and the number of winding times of the main magnetic pole 61a and the number of winding times of the adjust magnetic pole coil 63a can be changed. However, the invention is not limited thereto, and the configuration in which a current can be supplied to the main magnetic pole coil 61a independently of the adjustment magnetic pole coil 63a like the magnetic recording head 52 illustrated in FIG. 7 is also possible. Furthermore, this can be applied to all of the magnetic recording heads described above.

### Seventh Embodiment

Hereinafter, the magnetic recording apparatus and the magnetic head assembly according to a seventh embodiment of the invention will be described.

The magnetic recording head according to the embodiment of the invention described in the above description can be incorporated into, for example, a magnetic head assembly of an integrated type of recording and reproducing, and can be mounted on a magnetic recording apparatus. The magnetic recording apparatus according to this embodiment can have only the recording function, and can also have both of the recording function and the reproducing function.

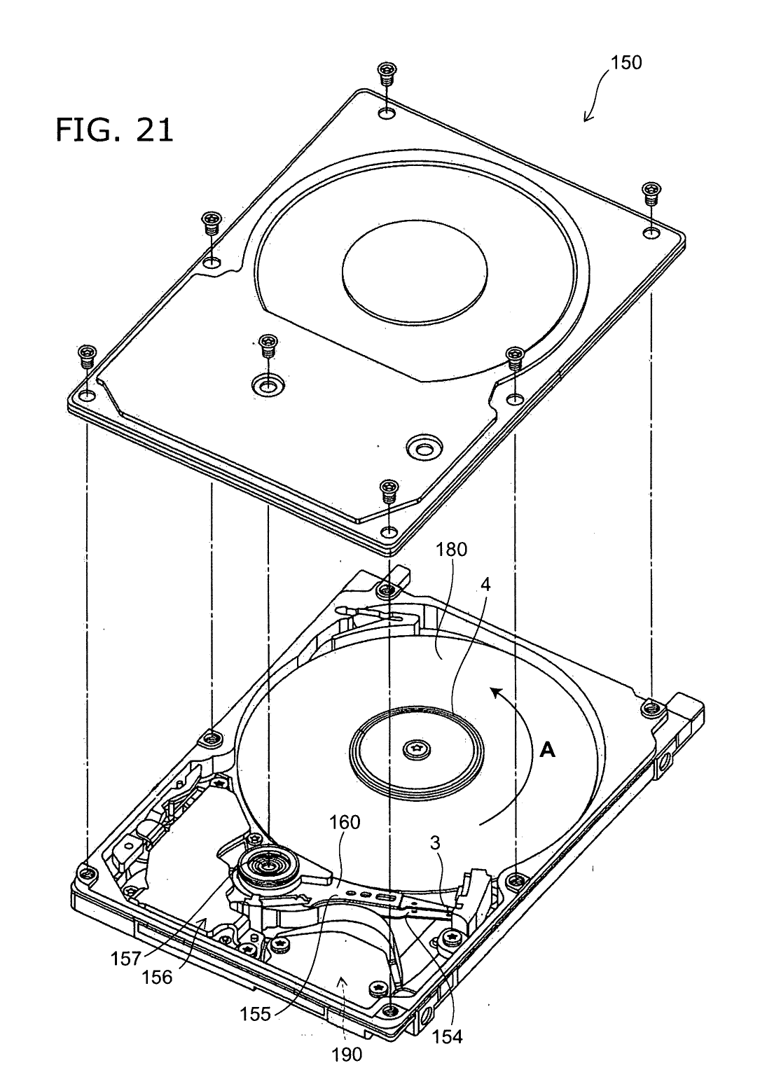

FIG. 21 is a schematic perspective view illustrating the configuration of the magnetic recording apparatus according to a seventh embodiment of the invention.

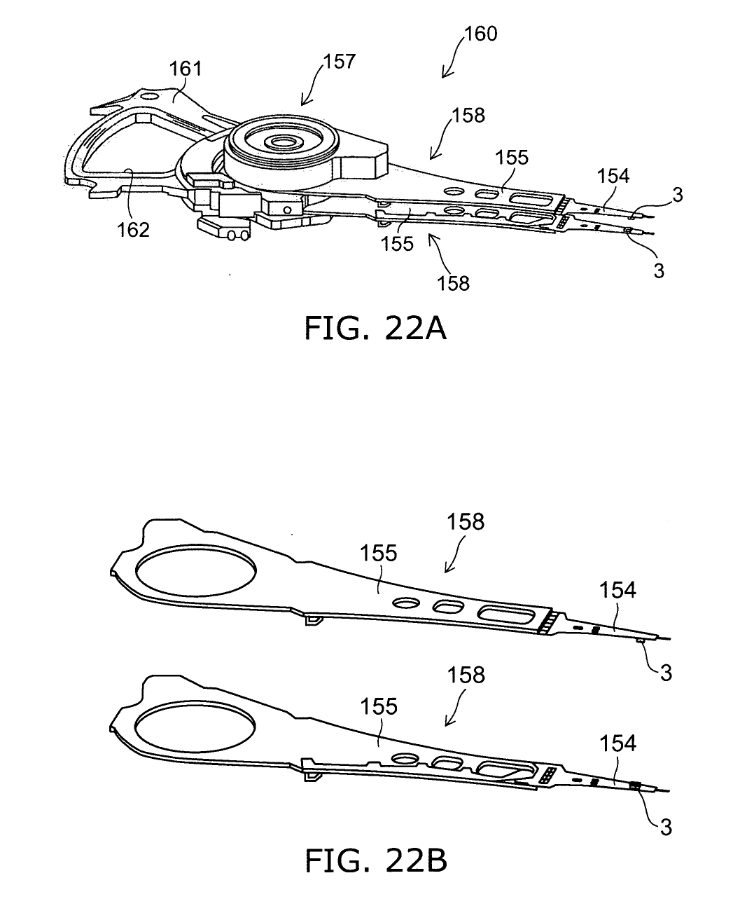

FIG. 22 is a schematic perspective view illustrating the configuration of part of the magnetic recording apparatus according to the seventh embodiment of the invention.

As shown in FIG. 21, the magnetic recording apparatus 150 according to the seventh embodiment of the invention is an apparatus of a type in which a rotary actuator is used. In FIG. 21, a recording medium disk 180 is mounted on a spindle motor 4, and rotated in the direction of the arrow A by a motor, which is not shown, responding to a control signal from a drive controller, which is not shown. The magnetic recording apparatus 150 according to this embodiment may have a plurality of the recording medium disks 180.

The head slider 3 for performing recording and reproducing information stored on the recording medium disk 180 has such a configuration as described previously with reference to FIG. 2 and is attached to a tip of a thin-film suspension 154. Here, the head slider 3 mounts, for example, the magnetic recording head according to any one of the above embodiments in the vicinity of the tip thereof.

When the recording medium disk 180 rotates, the compression pressure by the suspension 154 and the pressure generated in the air bearing surface (ABS) of the head slider 3 are balanced, and the air bearing surface of the head slider 3 is held with a predetermined floatation amount from the surface of the recording medium disk 180. So-called “contact traveling type” in which the head slider 3 contacts the recording medium disk 180 is also possible.

The suspension 154 is connected to one end of an actuator arm 155 having a bobbin for holding a driving coil, which is not shown. A voice coil motor 156 that is one kind of linear motors is provided on the other end of the actuator arm 155. The voice coil motor 156 can be composed of, a driving coil, which is not shown, wound up around the bobbin of the actuator arm 155 and a magnetic circuit including a permanent magnet and an opposed yoke disposed so as to sandwich the coil therebetween.

The actuator arm 155 is held by ball bearings, which is not shown, provided at two positions above and below a bearing 157, and can be glided and rotated by the voice coil motor 156. As a result, the magnetic recording head can be moved to an optional position on the recording medium disk 180.

FIG. 22A illustrates the configuration of part of the magnetic recording apparatus according to this embodiment and is an enlarged perspective view of a head stack assembly 160. FIG. 22B is a perspective view illustrating a magnetic head assembly (head gimbal assembly) 158 to be part of the head stack assembly 160.

As shown in FIG. 22A, a head gimbal assembly 158 has the actuator arm 155 extending from the bearing 157 and the suspension 154 extending from the actuator arm 155.

To the tip of the suspension 154, the head slider 3 having any one of the magnetic recording heads according to the embodiment of the invention described previously is attached. And, as described previously, on the head slider 3, a magnetic recording head according to the embodiment of the invention is mounted.

That is, the magnetic head assembly (head gimbal assembly) 158 according to the embodiment of the invention includes the magnetic recording head according to the embodiment of the invention, the head slider 3 on which the magnetic recording head is mounted, the suspension 154 mounting the head slider 3 on one end thereof, and the actuator arm 155 connected to the other end of the suspension 154.

The suspension 154 has lead wires (not show) for writing and reading signals, for heater for adjusting the floatation amount, for the spin torque oscillator and for the adjustment magnetic pole coil, and the lead wires are electrically connected to the electrodes of the magnetic recording head corporate into the head slider 3. Electrode pad, which is not shown, is provided in the head gimbal assembly 158. In this specific example, ten electrode pads are provided. That is, two electrode pads for the main magnetic pole coil 61a, two electrode pads for the magnetic reproducing element 71, two electrode pads for DFH (dynamic flying height), two electrode pads for the spin torque oscillator 10 and two electrode pads for the adjustment magnetic pole coil 63a are provided.

And, a signal processor 190 for writing and reading signals on the magnetic recording medium by using the magnetic recording head is provided. The signal processor 190 is, for example, provided on the back side of the figure of the magnetic recording apparatus 150 illustrated in FIG. 21. The input and output lines of the signal processor 190 are connected to the electrode pad of the head gimbal assembly 158 and electrically coupled to the magnetic recording head.

As described above, the magnetic recording apparatus 150 according to this embodiment has the magnetic recording medium, the magnetic recording head according to any one of the above embodiments, a movable section by which the magnetic recording medium and the magnetic recording head can be relatively moved with opposed to each other in the state of being separated from each other or contacting each other, a position controller of positioning the magnetic recording head to a predetermined recording position on the magnetic recording medium, and the signal processor for writing and reading signals on the magnetic recording medium by using the magnetic recording head.

That is, as the above magnetic recording medium, the recording medium disk 180 is used.

The above movable section can include the head slider 3.

The above position controller can include the head gimbal assembly 158.

That is, the magnetic recording apparatus 150 according to this embodiment includes the magnetic recording medium, the magnetic head assembly according to the embodiment of the invention, and the signal processor for writing and reading signals on the magnetic recording medium by using the magnetic recording head mounted on the magnetic head assembly.

According to the magnetic recording apparatus 150 according to this embodiment, by using magnetic recording head of any one of the above embodiments, stabilization and uniformization of the oscillation frequency of the spin torque oscillator is realized, and the magnetic recording head by which the stable high-frequency magnetic-field assist recording can be performed can be obtained.

### Eighth Embodiment

The magnetic recording apparatus 150a according to an eighth embodiment of the invention is based on the magnetic recording head in which currents can be supplied independently to the main magnetic pole coil 61a and the adjustment magnetic pole coil 63a. That is, for example, the magnetic recording heads 52, 52b, 52c of FIGS. 7, 9, and 12 can be used. Furthermore, the magnetic recording heads 50, 53, 53b to 53e, and 54 to 56 illustrated in FIGS. 13 to 20 can be based on the magnetic recording head having the configuration in which currents can be supplied independently to the main magnetic pole coil 61a and the adjustment magnetic pole coil 63a.

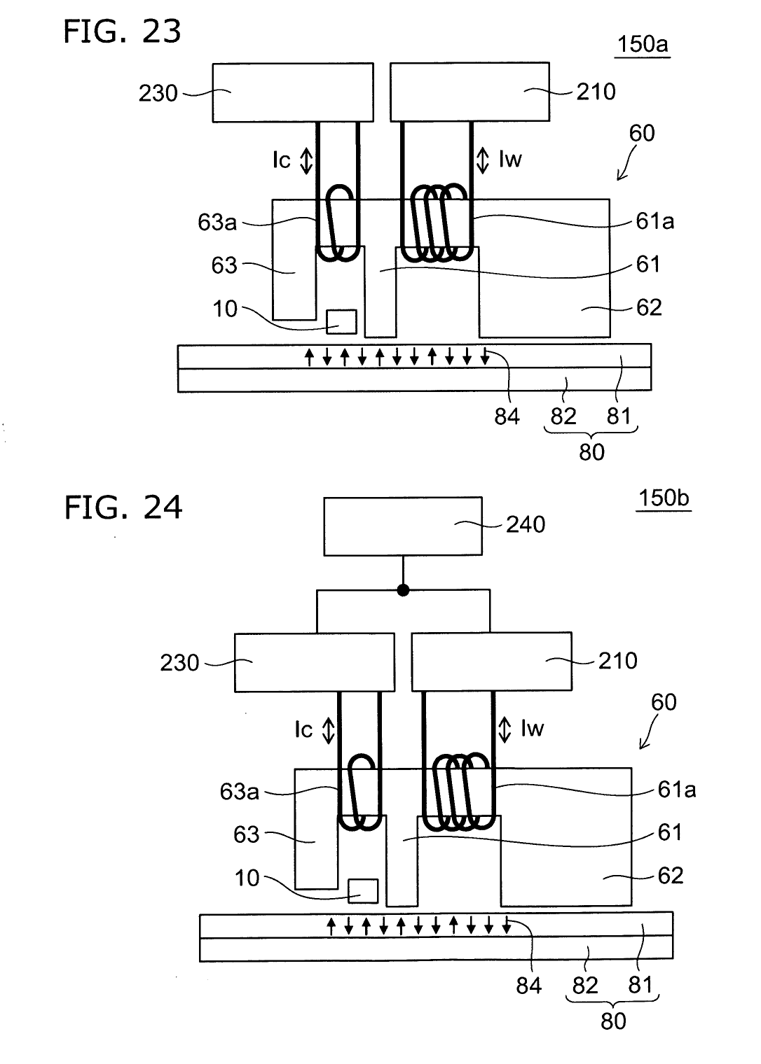

FIG. 23 is a schematic view illustrating the configuration of a relevant part of the magnetic recording apparatus according to the eighth embodiment of the invention.

As shown in FIG. 23, the magnetic recording apparatus 150a according to this embodiment includes, a recording current circuit 210 for supplying a recording current to the main magnetic pole coil 61a, and an adjustment magnetic pole circuit 230 for supplying a current to the adjustment magnetic pole coil 63a.

That is, the signal processor 190 includes, a recording current circuit 210 for supplying a recording current containing a signal to be recorded on the magnetic recording medium to the main magnetic pole coil 61a, and an adjustment magnetic pole circuit 230 for supplying an adjustment magnetic pole current to the adjustment magnetic pole coil 63a.

Other than this, the magnetic recording apparatus 150a can be the same as the magnetic recording apparatus 150 according to the seventh embodiment described in FIGS. 21, 22, the description thereof will be omitted.

In the magnetic recording apparatus 150a according to this embodiment, the recording current circuit 210 is connected to the main magnetic pole coil 61a and the adjustment magnetic pole circuit 230 is connected to the adjustment magnetic pole coil 63a. In the specific example illustrated in FIG. 23, in the main magnetic pole coil 61a and the adjustment magnetic pole coil 63a, four wires are independently provided. However, one wire may be shared and thereby three wires may be used.

The recording current circuit 210 and the adjustment magnetic pole circuit 230 pass the recording current Iw and the adjustment magnetic pole current Ic illustrated in FIGS. 10A to 11B through the main magnetic pole coil 61a and the adjustment magnetic pole 63a, respectively.

The adjustment magnetic pole circuit 230 can supply the adjustment magnetic pole current Ic controlled independently of the recording current Iw to the adjustment magnetic pole coil 63a. For example, at least any one of amplitude, phase, and direct-current component of the adjustment magnetic pole current Ic can be set to be different from the recording current Iw. For example, the adjustment magnetic pole circuit 230 can supply the adjustment magnetic pole current Ic varying in synchronization with the reversal of polarity of the recording current Iw to the adjustment magnetic pole coil 63a. Furthermore, the adjustment magnetic pole circuit 230 can supply the adjustment magnetic pole current Ic whose polarity changes in synchronization with the reversal of polarity of the recording current Iw to the adjustment magnetic pole coil 63a. In this case, the polarity of the adjustment magnetic pole current Ic changes in synchronization with the reversal of polarity of the recording current Iw, and can be the same polarity (the same phase) as the polarity of the recording current Iw. The polarity of the adjustment magnetic pole current Ic changes in synchronization with the reversal of polarity of the recording current Iw, and can be the reversed polarity (the reversed phase) to the polarity of the recording current Iw.

Thereby, for example, the most appropriate recording magnetic fields are different among the inner circumference and the intermediate circumference and the outer circumference of the recording medium disk 180, and when the amplitude of the recording current Iw is varied, the adjustment magnetic pole current Ic can be different among the inner circumference and the intermediate circumference and the outer circumference so as to correspond to variation of the magnetic field applied by the main magnetic pole 61 to the spin torque oscillator 10. Thereby, the sum of the magnetic field by the main magnetic pole 61 applied to the spin torque oscillator 10 and the magnetic field by the adjustment magnetic pole 63 can be constant, and it becomes possible to hold the oscillation state of the spin torque oscillator 10 to be constant. As a result, independently of track position of the recording medium disk, the oscillation state of the spin torque oscillator 10 can be uniform, and the stable high-frequency magnetic-field assist recording can be performed.

Furthermore, even if there is fluctuation in characteristics of the magnetic recording heads, the intensity of the magnetic field received by the spin torque oscillator 10 can be constant, and the oscillation frequency of the spin torque oscillator 10 can be set to be substantially constant.

For example, when the recording current circuit 210 and the adjustment magnetic pole circuit 230 are not separated, the magnetic recording head and the magnetic recording medium require design and manufacturing that are sufficiently resistant to fluctuation of the characteristics. Therefore, for example, occasionally, it is very difficult to realize the high-density recording by using a high-Ku medium.

By contrast, in the magnetic recording apparatus 150a according to this embodiment, by separating the recording current circuit 210 and the adjustment magnetic pole circuit 230, the most appropriate recording current Iw and the most appropriate adjustment magnetic pole current Ic can be easily set for the individual head, and the high-density recording by using high-Ku medium is easily realized.

That is, in the magnetic recording heads, physical properties such as saturation magnetic flux density, magnetic permeability or the shape of the floated-surface structure or the like are displaced from each of the most appropriate values, and the displacement amounts thereof vary in each of the magnetic recording heads. The oscillation state of the spin torque oscillator varies in each of the magnetic recording heads. Furthermore, the resonant frequency of the magnetic recording medium varies in each of the magnetic recording media. In the magnetic recording apparatus 150b according to this embodiment, such an adjustment magnetic pole current Ic as minimizing the influence due to the variations can be applied, and independently of the magnetic recording heads and the magnetic recording media, stable and uniform high-frequency magnetic-field assist becomes possible.

As described above, in the magnetic recording apparatus 150a according to this embodiment, stabilization and uniformization of the oscillation frequency of the spin torque oscillator is realized, and the magnetic recording apparatus by which the stable high-frequency magnetic-field assist recording can be performed can be provided.

The recording current Iw may overshoot during the reversal of polarity. By the overshoot, magnetization reversal speed of the main magnetic pole 61 is increasesed and the line recording density can be improved.

The adjustment magnetic pole current Ic may overshoot during the reversal of polarity. By the overshoot, the reversal speed of the oscillation state of the spin torque oscillator 10 is increased and the line recording density can be improved.

### Ninth Embodiment

FIG. 24 is a schematic view illustrating the configuration of a relevant part of another magnetic recording apparatus according to a ninth embodiment of the invention.

As shown in FIG. 24, another recording apparatus 150b according to the ninth embodiment of the invention further includes a recording signal circuit 240 for supplying an electric signal to the recording current circuit 210, with respect to the magnetic recording apparatus 150a according to the eighth embodiment. Other than this, the magnetic recording apparatus 150b can be the same as the magnetic recording apparatus 150a according to the eighth embodiment illustrated in FIG. 23, and thus, the description thereof will be omitted.

During recording data on the magnetic recording medium (recording medium disk 180), the magnetic recording apparatus 150b according to this embodiment can supply the electric signal according to the data to the recording current circuit 210 by the recording signal circuit 240.

For example, the recording signal circuit 240 is a read/write channel included in an electronic circuit of the magnetic recording apparatus 150, and supplies the recording signal Sw that is the modulated recording data to be written on the magnetic recording medium (recording medium disk 180) to the recording current circuit 210.

Furthermore, as shown in FIG. 24, the electric signal output from the recording signal circuit 240 can be inputted to the adjustment magnetic pole circuit 230. And, based on the electric signal from the recording signal circuit 240, the adjustment magnetic pole current Ic can be generated by the adjustment magnetic pole circuit. Thereby, the recording current Iw generated based on the electric signal from the recording signal circuit and the adjustment magnetic pole current Ic generated based on the same electric signal can be provided with a desired correlation.

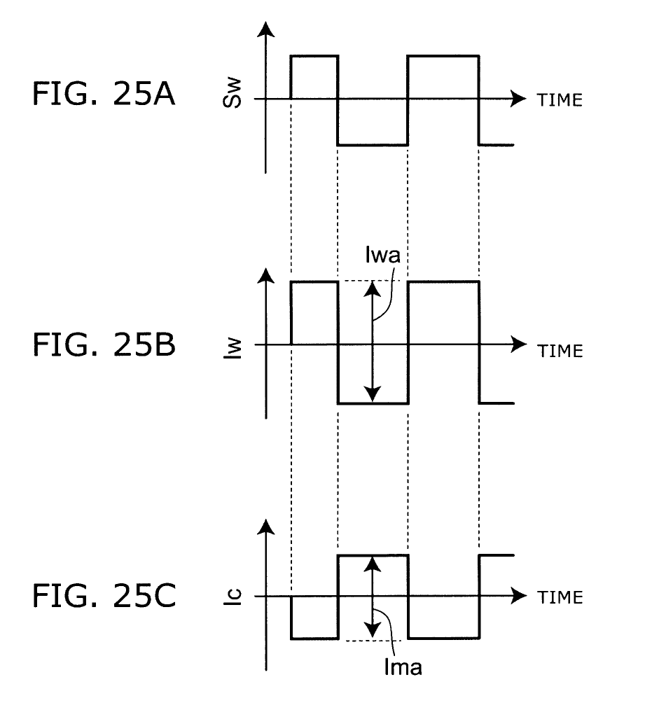

FIGS. 25A to 25C are schematic views illustrating operation of the magnetic recording apparatus according to the ninth embodiment of the invention.

That is, FIG. 25A illustrates the electric signal output from the recording signal circuit 240, namely, recording signal Sw in the magnetic recording apparatus 150b according to this embodiment, and FIG. 25B illustrates the current passed through the main magnetic pole coil 61a, namely, the recording current Iw, and FIG. 25C illustrates the adjustment magnetic pole current Ic passed through the adjustment magnetic pole coil 63a. In these figures, the horizontal axis represents time, and the vertical axes represent the recording signal Sw, the recording current Iw, and the adjustment magnetic pole current Ic, respectively.

As shown in FIGS. 25A to 25C, the recording signal circuit 240 supplies the recording signal Sw as the electric signal to the recording current circuit 210. The recording current circuit 210 generates the recording current Iw based on the recording signal Sw and supplies the recording current Iw to the main magnetic pole 61a. The magnetic field based on the recording current Iw is applied to the magnetic recording medium (recording medium disk 180) and the spin torque oscillator 10.

On the other hand, the recording signal Sw of the recording signal circuit 240 is also supplied to the adjustment magnetic pole circuit 230. Based thereon, the adjustment magnetic pole circuit 230 generates the adjustment magnetic pole current Ic synchronized with, for example, the variation of the recording signal Sw and supplies the adjustment magnetic pole current Ic to the adjustment magnetic pole coil 63a. Thereby, from the adjustment magnetic pole coil 63a, the magnetic field synchronized with the recording signal Sw is generated and applied to the spin torque oscillator 10. In this case, by appropriately adjusting amplitude or polarity of the adjustment magnetic pole current Ic, the oscillation frequency of the spin torque oscillator 10 can be constant.

That is, the recording signal circuit 240 can supply an electric signal to the recording current circuit 210 so that an appropriate recording current Iw is generated on the basis of which position of the inner circumference, the intermediate circumference and the outer circumference the position to be the target of recording on the magnetic recording medium (recording medium disk 180) belongs to. Thereby, the recording current circuit 210 can generate the appropriate recording current Iw. On the other hand, by the electric signal supplied from the recording signal circuit 240, the adjustment magnetic pole circuit 230 can generate the appropriate adjustment magnetic pole current Ic on the basis of which position of the inner circumference, the intermediate circumference and the outer circumference the position to be the target of recording in the magnetic recording medium (recording medium disk 180) belongs to. That is, the adjustment magnetic pole circuit 230 can appropriately set, for example, amplitude, polarity, direct-current component, and so forth with respect to the recording current Iw and can supply the adjustment magnetic pole current Ic to the adjustment magnetic pole coli 63a so that the oscillation frequency of the spin torque oscillator 10 is substantially constant.

In the specific example of FIGS. 25A to 25C, polarity of the adjustment magnetic pole current Ic varies with reversed polarity (reversed phase) in synchronization with the recording current Iw. Therefore, the magnetic field from the main magnetic pole 61 and the magnetic field from the adjustment magnetic pole 63 that are applied to the spin torque oscillator 10 are cancelled to each other. Thereby, this is an example of controlling the oscillation frequency of the spin torque oscillator 10 to be constant. However, the invention is not limited thereto, and the adjustment magnetic pole current Ic may vary with the same polarity and may be adjusted so that the oscillation frequency of the spin torque oscillator 10 is substantially constant.

As described above, it can be realized with further better controllability that based on the electric signal supplied from the recording signal circuit 240, the adjustment magnetic pole circuit 230 adjusts the adjustment magnetic pole current Ic so that the oscillation frequency of the spin torque oscillator 10 becomes substantially constant independently of amplitude or polarity of the recording current Iw.

As described above, in the magnetic recording apparatus 150b according to this embodiment, stabilization and uniformization of the oscillation frequency of the spin torque oscillator is realized, and the magnetic recording apparatus by which the stable high-frequency magnetic-field assist recording can be performed can be provided.

### Tenth Embodiment

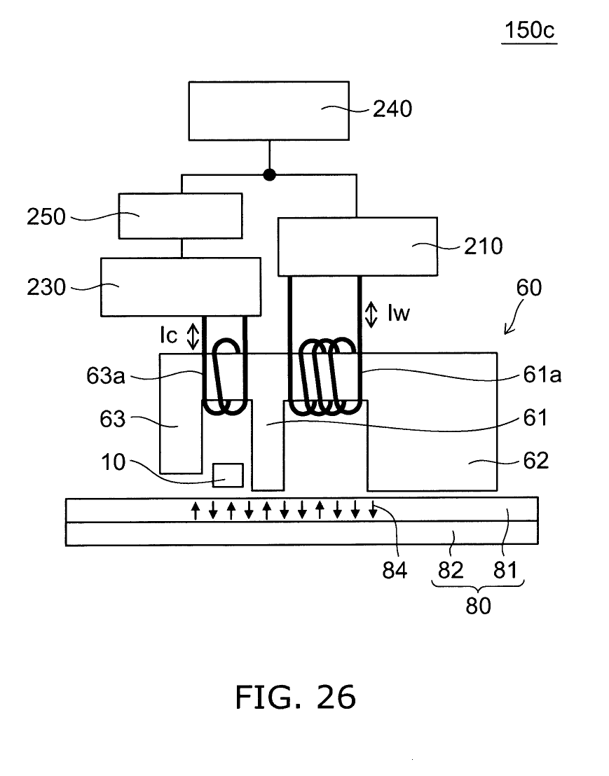

FIG. 26 is a schematic view illustrating the configuration of the magnetic recording apparatus according to a tenth embodiment of the invention.

As shown in FIG. 26, the magnetic recording apparatus 150c according to the tenth embodiment of the invention further includes a phase adjustment circuit 250 to which the electric signal (recording signal Sw) from the recording signal circuit 240 is inputted and which supplies the phase adjustment electric signal in which the phase of the electric signal is adjusted to at least any one of the recording current circuit 210 and the adjustment magnetic pole circuit 230, with respect to the magnetic recording apparatus 150b according to the ninth embodiment. Other than this, the magnetic recording apparatus 150c can be the same as the ninth embodiment, and thus, the description thereof will be omitted.

In the magnetic recording apparatus 150c of the specific example illustrated in FIG. 26, the electric signal (recording signal Sw) from the recording signal circuit 240 is inputted to the phase adjustment circuit 250, and the phase adjustment circuit 250 supplies the phase adjustment electric signal in which the phase of the electric signal is adjusted to the adjustment magnetic pole circuit 230. The phase adjustment circuit 250 is disposed between the recording signal circuit 240 and the adjustment magnetic pole circuit 230. And, the phase adjustment circuit 250 can be, for example, a front phase compensation circuit or a delay circuit. Thereby, the phase of the adjustment magnetic pole current Ic can be advanced or delayed by a predetermined phase with respect to the recording signal Sw.

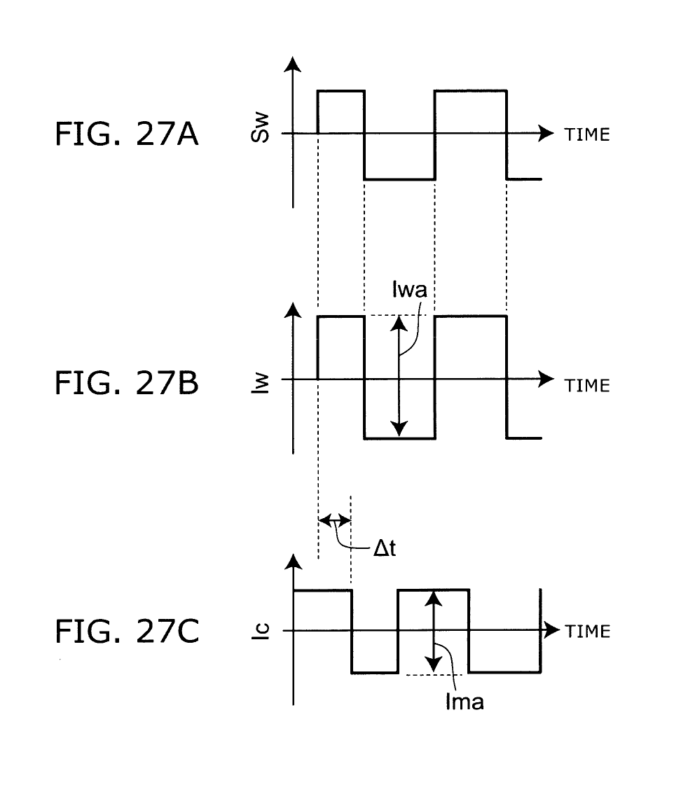

FIGS. 27A to 27C are schematic views illustrating the operation in the magnetic recording apparatus according to the tenth embodiment of the invention.

That is, FIG. 27A illustrates the electric signal output from the recording signal circuit, namely, recording signal Sw in the magnetic recording apparatus 150c according to this embodiment, and FIG. 27B illustrates the current passed through the main magnetic pole coil 61a, namely, the recording current Iw, and FIG. 27C illustrates the adjustment magnetic pole current Ic passed through the adjustment magnetic pole coil 63a. In these figures, the horizontal axis represents time, and the vertical axes represent the recording signal Sw, the recording current Iw, and the adjustment magnetic pole current Ic, respectively.

As shown in FIGS. 27A to 27C, in the magnetic recording apparatus 150c according to this embodiment, the recording current Iw varies with the same phase and the same polarity in synchronization with the recording signal Sw. By contrast, the phase of the adjustment magnetic pole current Ic can be advanced or delayed by a predetermined phase, namely, a predetermined time Δt with respect to the recording signal Sw.

As described previously, for example, in the case that the adjustment magnetic pole current Ic is varied in synchronization with the reversal of polarity of the recording current Iw, namely, in the case that Δt is zero, occasionally, the time until the oscillation frequency of the spin torque oscillator 10 reaches a certain value becomes longer than the time required for the reversal of polarity of the recording current Iw. In such a case, it is effective to delay the phase of the adjustment magnetic pole current Ic by the predetermined time Δt with respect to the recording current Iw. That is, in the period of Δt from the reversal of the recording current Iw, the magnetic field applied by the adjustment magnetic pole 63 to the spin torque oscillator 10 and the magnetic field applied by the main magnetic pole 61 to the spin torque oscillator 10 come to have the direction of enhancing each other. Thereby, reversal of the oscillation state of the spin torque oscillator 10 becomes more rapid. As a result, the apparatus by which the stable and high-quality high-frequency magnetic-field assist recording can be performed can be realized.

As described above, in another magnetic recording apparatus 150c according to this embodiment, the efficiency is more enhanced by setting the reversal of the oscillation state of the spin torque oscillator to be more rapid, and stabilization and uniformization of the oscillation frequency of the spin torque oscillator is realized, and the magnetic recording apparatus by which the stable high-frequency magnetic-field assist recording can be performed can be provided.

In the magnetic recording apparatus according to the embodiment of the invention, the spin torque oscillator 10 can be provided on the trailing side of the main magnetic pole 61. In this case, the magnetic recording layer 81 of the magnetic recording medium 80 is first opposed to the spin torque oscillator 10 and then opposed to the main magnetic pole 61. That is, when the magnetic recording head of the magnetic recording apparatus has a reading section, the spin torque oscillator 10 can be provided on the opposite side to the reading section 70 of the main magnetic pole 61 as illustrated in, for example, FIGS. 13, 14, and 17.

In the magnetic recording apparatus according to the embodiment of the invention, the spin torque oscillator 10 can be provided on the reading side of the main magnetic pole 61. In this case, the magnetic recording layer 81 of the magnetic recording medium 80 is first opposed to the main magnetic pole 61 and then opposed to the spin torque oscillator 10. That is, when the magnetic recording head of the magnetic recording apparatus has a reading section, the spin torque oscillator 10 can be provided in the side of the reading section 70 of the main magnetic pole 61 as illustrated in, for example, FIGS. 1, 15, and 16.

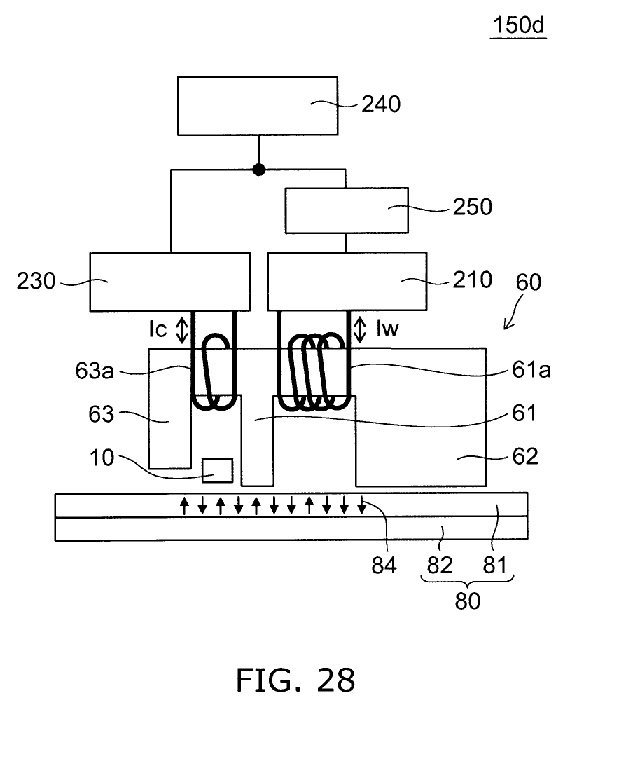

FIG. 28 is a schematic view illustrating the configuration of another magnetic recording apparatus according to the tenth embodiment of the invention.

As shown in FIG. 28, in the magnetic recording apparatus 150d according to the tenth embodiment of the invention, the phase adjustment circuit 250 in the magnetic recording apparatus 150c is provided between the recording signal circuit 240 and the recording current circuit 210.

Also in this case, the efficiency is more enhanced by setting the reversal of the oscillation state of the spin torque oscillator to be more rapid, and stabilization and uniformization of the oscillation frequency of the spin torque oscillator is realized the magnetic recording apparatus by which the stable high-frequency magnetic-field assist recording can be performed can be provided.

Hereinafter, the magnetic recording medium that can be used for the magnetic recording apparatus of the above embodiment will be described.

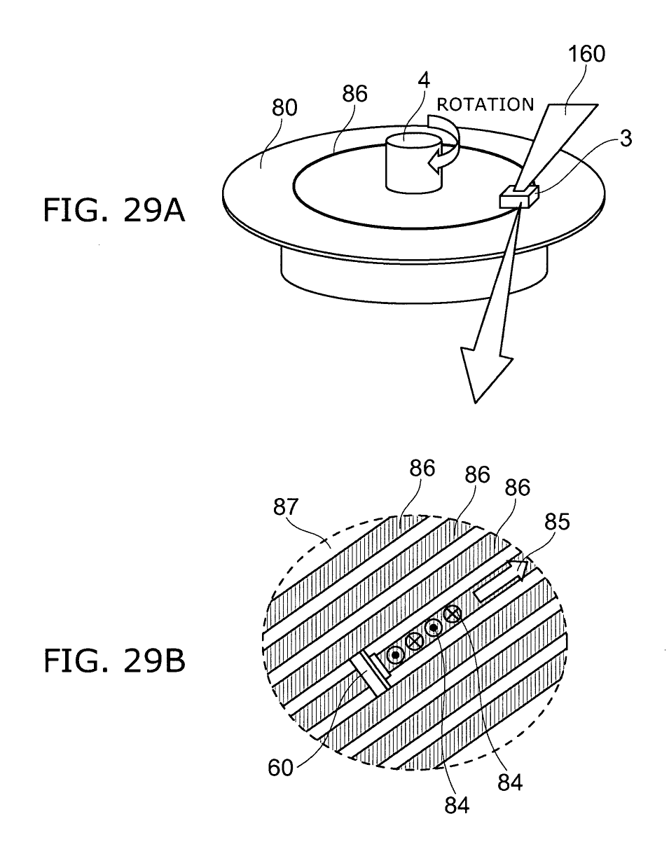

FIGS. 29A and 29B are schematic perspective views illustrating the configuration of the magnetic recording medium of the magnetic recording apparatus according to the embodiment of the invention.

As shown in FIGS. 29A and 29B, the magnetic recording medium 80 used for the magnetic recording apparatus according to the embodiment of the invention has magnetic discrete tracks (recording tracks) 86 of multiparticle that are separated from each other by nonmagnetic body (or air) 87 and oriented perpendicularly. When the magnetic recording medium 80 is rotated by the spindle motor 4 and moves in the medium moving direction 85, any one of the magnetic recording heads of the above embodiments is provided and thereby the recording magnetization 84 can be formed.

As described above, in the magnetic recording apparatus according to the embodiment of the invention, the magnetic recording medium 80 can be the discrete track medium in which the adjacent recording tracks are formed through a nonmagnetic member.

By setting the width (TS) in the recording track width direction of the spin torque oscillator 10 to be from the width (TW) of the recording track 86 to the recording track pitch (TP), coercivity lowering of the adjacent recording tracks by the leaking high-frequency magnetic field generated from the spin torque oscillator 10 can be drastically suppressed. Therefore, in the magnetic recording medium 80 of this specific example, only the recording track 86 to be desired to be recorded can be effectively subjected to high-frequency magnetic field assist recording.

According to this specific example, as compared to the case of using so-called “blanket film” multiparticle-based perpendicular medium, it is easy to realize the high-frequency assist recording apparatus with narrow track, namely, high track density. By utilizing the high-frequency magnetic field assist recording scheme and further by using a medium magnetic material having high magnetic anisotropic energy (Ku) such as FePt or SmCo in which writing is impossible by a conventional magnetic recording head, the medium magnetic particles can be further finer to the size of nanometers, and it is possible to realize the magnetic recording apparatus in which linear recording density is far higher than that of conventional technique in the recording track direction (bit direction).

According to the magnetic recording apparatus according to this embodiment, in the discrete-type magnetic recording medium 80, recording can be reliably performed also on the magnetic recording layer having high coercivity, and thus high-density and high-speed magnetic recording becomes possible.

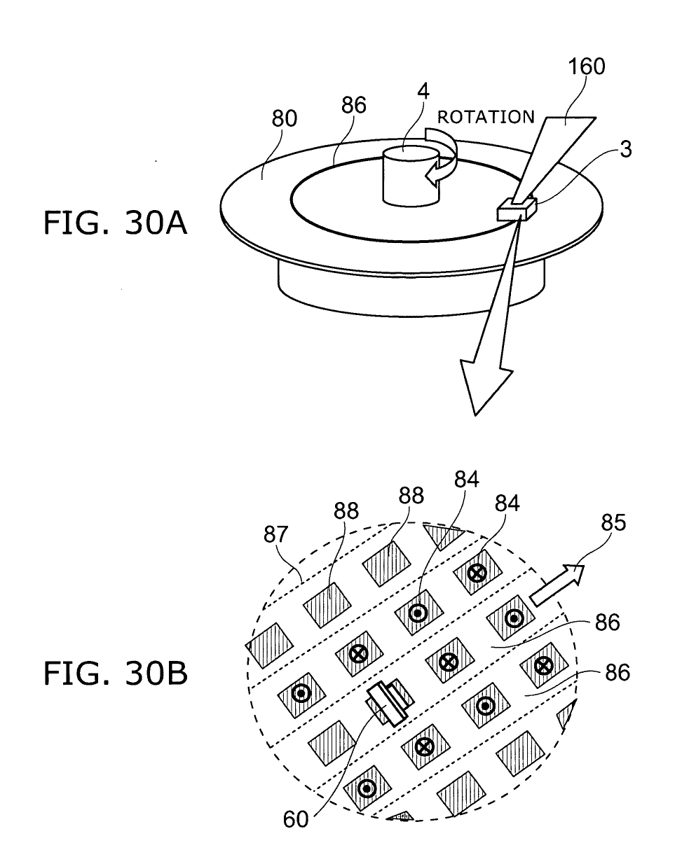

FIGS. 30A and 30B are schematic perspective views illustrating the configuration of another magnetic recording medium of the magnetic recording apparatus according to the embodiment of the invention.

As shown in FIGS. 30A and 30B, in another magnetic recording medium 80 that can be used for the magnetic recording apparatus according to the embodiment of the invention has magnetic discrete bits 88 that are separated from one another by a nonmagnetic body 87. When the magnetic recording medium 80 is rotated by the spindle motor 4 and moves in the medium moving direction 85, the recording magnetization 84 can be formed by the magnetic recording head according to the embodiment of the invention.

As described above, in the magnetic recording apparatus according to the embodiment of the invention, the magnetic recording medium 80 can be the discrete bit medium in which the independent recording magnetic dots are regularly arranged and formed through a nonmagnetic member.

According to the magnetic recording apparatus according to this embodiment, in the discrete-type magnetic recording medium 80, recording can be reliably performed also on the magnetic recording layer having high coercivity, and thus high-density and high-speed magnetic recording becomes possible.

Also in this specific example, by setting the width (TS) in the recording track width direction of the spin torque oscillator 10 to be from the width (TW) of the recording track 86 to the recording track pitch (TP), coercivity lowering of the adjacent recording tracks by the leaking high-frequency magnetic field generated from the spin torque oscillator 10 can be drastically suppressed. Therefore, only the recording track 86 to be desired to be recorded can be effectively subjected to high-frequency magnetic field assist recording. By using this specific example, as long as the resistance to thermal fluctuation under the operating environment can be held, by increasing magnetic anisotropic energy (Ku) of the magnetic discrete bit 88 and downscaling it, there is a possibility of realizing the high-frequency magnetic field assist recording apparatus with high recording density of 10 Tbits/inch² or more.

As described above, the embodiments of the invention have been described with reference to specific examples. However, the invention is not limited to the specific examples. For example, the specific configuration of each of the components composing the magnetic recording head, the magnetic head assembly, and the magnetic recording apparatus is included in the scope of the invention, as long as the invention can be carried out by appropriate selection from the known range by those skilled in the art and the same effect can be obtained.

Moreover, combination of two or more components of the respective specific examples in the technically possible range is included in the scope of the invention as long as including the spirit of the invention.

In addition, all of the magnetic recording heads, the magnetic head assemblies, and the magnetic recording apparatuses that can be carried out with appropriately design-modified by those skilled in the art on the basis of the magnetic recording heads, the magnetic head assemblies, and the magnetic recording apparatuses described above as the embodiments of the invention belong to the scope of the invention as long as including the spirit of the invention.

In addition, it is understood that those skilled in the art can achieve various variations and modified examples and that the variations and the modified examples belong to the scope of the invention.

1. A magnetic head assembly comprising:
a magnetic recording head including:
a main magnetic pole;
an adjustment magnetic pole provided together with the main magnetic pole;
a spin torque oscillator, at least part of the spin torque oscillator being provided between the main magnetic pole and the adjustment magnetic pole;
a main magnetic pole coil configured to be wound around the main magnetic pole; and
an adjustment magnetic pole coil configured to be wound around the adjustment magnetic pole, a way of winding of the adjustment magnetic pole coil being different from a way of winding of the main magnetic pole coil;
a head slider, the magnetic recording head being mounted on the head slider;
a suspension, the head slider being mounted on one end of the suspension; and
an actuator arm connected to other end of the suspension.

2. The assembly according to claim 1, wherein the adjustment magnetic pole coil has a number of winding times different from a number of winding times of the main magnetic pole coil.

3. The assembly according to claim 1, wherein the adjustment magnetic pole coil has a winding direction different from a winding direction of the main magnetic pole coil.

4. The assembly according to claim 1, wherein the adjustment magnetic pole coil is recessed from the main magnetic pole as viewed from the magnetic recording medium.

5. The assembly according to claim 1, wherein the magnetic recording head further includes a side shield provided opposed to a side surface of at least any one of the main magnetic pole and the spin torque oscillator.

6. The assembly according to claim 1, wherein the spin torque oscillator includes a stacked body including:
a first magnetic layer having a smaller coercivity than a magnetic field applied by the main magnetic pole;
a second magnetic layer having a smaller coercivity than the magnetic field applied by the main magnetic pole; and
an intermediate layer provided between the first magnetic layer and the second magnetic layer.

7. The assembly according to claim 6, wherein the stacked body further includes a third magnetic layer provided on an opposite side to the intermediate layer of the first magnetic layer and having a smaller coercivity than the magnetic field applied by the main magnetic pole.

8. A magnetic head assembly comprising:
a magnetic recording head including:
a main magnetic pole;
an adjustment magnetic pole provided together with the main magnetic pole;
a spin torque oscillator, at least part of the spin torque oscillator being provided between the main magnetic pole and the adjustment magnetic pole;
a main magnetic pole coil configured to be wound around the main magnetic pole; and
an adjustment magnetic pole coil configured to be wound around the adjustment magnetic pole, a current being supplied to the adjustment magnetic coil independently of the main magnetic pole coil;
a head slider, the magnetic recording head being mounted on the head slider;
a suspension, the head slider being mounted on one end of the suspension; and
an actuator arm connected to other end of the suspension.

9. The assembly according to claim 8, wherein the adjustment magnetic pole coil has a number of winding times different from a number of winding times of the main magnetic pole coil.

10. The assembly according to claim 8, wherein the adjustment magnetic pole coil has a winding direction different from a winding direction of the main magnetic pole coil.

11. The assembly according to claim 8, wherein the adjustment magnetic pole coil is recessed from the main magnetic pole as viewed from the magnetic recording medium.

12. The assembly according to claim 8, wherein the magnetic recording head further includes a side shield provided opposed to a side surface of at least any one of the main magnetic pole and the spin torque oscillator.

13. The assembly according to claim 8, wherein the spin torque oscillator includes a stacked body including:
a first magnetic layer having a smaller coercivity than a magnetic field applied by the main magnetic pole;
a second magnetic layer having a smaller coercivity than the magnetic field applied by the main magnetic pole; and
an intermediate layer provided between the first magnetic layer and the second magnetic layer.

14. The assembly according to claim 13, wherein the stacked body further includes a third magnetic layer provided on an opposite side to the intermediate layer of the first magnetic layer and having a smaller coercivity than the magnetic field applied by the main magnetic pole.

15. A magnetic recording apparatus comprising:
a magnetic recording medium;
a magnetic head assembly including:
a magnetic recording head including;
a main magnetic pole,
an adjustment magnetic pole provided together with the main magnetic pole;
a spin torque oscillator, at least part of the spin torque oscillator being provided between the main magnetic pole and the adjustment magnetic pole;
a main magnetic pole coil configured to be wound around the main magnetic pole; and
an adjustment magnetic pole coil configured to be wound around the adjustment magnetic pole, a way of winding of the adjustment magnetic pole coil being different from a way of winding of the main magnetic pole coil;
a head slider, the magnetic recording head being mounted on the head slider;
a suspension, the head slider being mounted on one end the suspension; and
an actuator arm connected to the other end of the suspension; and
a signal processor configured to write and read a signal on the magnetic recording medium by using the magnetic recording head mounted on the magnetic head assembly.

16. The apparatus according to claim 15, wherein the spin torque oscillator is provided on a trailing side of the main magnetic pole.

17. The apparatus according to claim 15, wherein the spin torque oscillator is provided on a reading side of the main magnetic pole.

18. The apparatus according to claim 15, wherein the magnetic recording medium is a discrete track medium in which adjacent recording tracks are formed through a nonmagnetic member.

19. The apparatus according to claim 15, wherein the magnetic recording medium is a discrete bit medium in which independent recording magnetic dots are regularly arranged and formed through a nonmagnetic member.
